(19) United States
(12) Patent Application Publication
(10) Pub. No.: US 2014/0207911 A1
(43) Pub. Date: Jul. 24, 2014

(54) SYSTEM AND METHOD FOR EMBEDDING MULTIMEDIA CONTROLS AND INDICATIONS IN A WEBPAGE

(71) Applicants: James Kosmach, Geneva, IL (US); Andrew Jenkins, Charlotte, NC (US); Christian Gran, Falkensee (DE); Greg Sherwood, Inverness (IL); Osama Al-Shaykh, San Diego, CA (US)

(72) Inventors: James Kosmach, Geneva, IL (US); Andrew Jenkins, Charlotte, NC (US); Christian Gran, Falkensee (DE); Greg Sherwood, Inverness (IL); Osama Al-Shaykh, San Diego, CA (US)

(21) Appl. No.: 13/747,056

(22) Filed: Jan. 22, 2013

(51) Int. Cl. H04L 29/06

(52) U.S. Cl. CPC H04L 29/06027
USPC 709/218

(57) ABSTRACT

A system and a method embed multimedia controls and indications in a webpage which may provide access to internet media content. The multimedia controls and indications embedded in the webpage may be accessible using a standard web browser and may enable a user of the standard web browser to invoke enhanced media functions for internet media content available through the webpage. The enhanced browser functions may include redirection of the internet media content to a rendering device in a home network, and the rendering device may be a different device than the browser terminal. The enhanced browser functions may include downloading the internet media content to a media server or other local storage device in the network, and the media server and the other local storage device may each be a different device than the browser terminal.

### BACKGROUND OF THE INVENTION

The present invention generally relates to a system and a method for embedding multimedia controls and indications in a webpage which may provide access to internet media content objects. More specifically, the multimedia controls and indications embedded in the webpage may be accessible using a standard web browser and may enable a user of the standard web browser to invoke enhanced media functions for the internet media content objects available through the webpage.

The internet has a large and still growing number of multimedia content websites which offer access to multimedia content objects, such as digital photographs, digital music files and/or streams, digital video files and/or streams, and/or the like. Multimedia content websites provide webpages which enable access to the multimedia content objects. Users may browse the webpages using a device equipped with a standard web browser (hereafter a “browser terminal”) and then may consume the multimedia content objects using a multimedia player on the browser terminal. The multimedia player may be a part of the standard browser, may be an addition to the standard web browser in the form of a “browser plug-in,” may be an application installed on the browser terminal by the user, may be embedded in the content of the webpage, or may be a combination of these multimedia player types.

Media content websites may provide limited media management functionality embedded in the content of the webpage, known as “in-page” tools. For example, some music websites allow a user to build a playlist using music content objects available on the website. However, the functionality for in-page tools is typically limited to the content objects of the specific associated website. Also, the available tools, tool functionality, and user interface for in-page tools varies between content websites. Thus, the in-page tools do not provide a satisfactory experience for a user who accesses media content objects from multiple media content websites.

Media management applications, such as RealPlayer (trademark of RealNetworks, Inc.), SimpleCenter (trademark of Universal Electronics Inc.), iTunes (trademark of Apple Computer, Inc.) and Twonky Media Manager (trademark of PacketVideo Corporation) enable the user to perform a multitude of media management, organization, consumption and/or redirection functions using media files in a media library. The media library may be associated with the media management application and/or may be located on one or more local media servers and/or local content storage locations which may be accessible to the media management application. A disadvantage of media management applications is that the media management application is a separate experience from the web browser. As a result, multimedia content discovered through the web browser typically must be saved in a local media library or a local media server before the multimedia content may be used outside of the web browser within a media management application.

Some web browser plug-ins provide enhanced functionality for multimedia content in a webpage. Notable examples are the RealPlayer browser plug-in, Coollris (trademark of Cooliris, Inc.), and TwonkyBeam (trademark of PacketVideo Corporation and example embodiments of which are disclosed in U.S. Patent App. Pub. No. 2011/0060998 to Schwartz et al., assigned to the assignee of the present application and herein incorporated by reference in its entirety). The RealPlayer plug-in allows the user to download videos from a webpage and add the downloaded videos to the media library associated with the separate RealPlayer application. The Coollris plug-in provides enhanced visualization and management functionality for digital photos and videos on certain content websites supported by the plug-in. The TwonkyBeam plug-in may detect internet media content objects available from a webpage and may present additional controls for redirecting the media to one or more rendering devices available in a home network. However, each of these plug-ins require the user to have a web browser which supports the plug-in. For example, web browsers on portable devices and mobile devices do not currently support such plug-ins.

FIG. 1 generally illustrates a prior art system 10 which has a browser terminal 11. A user 12 utilizes a web browser provided by the browser terminal 11 to access internet media content websites 20 over the internet 15. Each of the internet media content websites 20 may be one or more web servers combined with one or more media servers. The browser terminal 11 may be any device which has a standard web browser, such as, for example, a desktop computer, a laptop computer, a netbook, a mobile phone, a PDA, a gaming device, a web-enabled television, and/or the like.

The web browser presents standard browser controls which allow the user to select, navigate to and/or request a webpage provided by one of the internet media content websites 20. As a result, the web browser may retrieve the webpage and the various elements on which the webpage may depend. The web browser may display a rendered webpage which the user 12 may view, which the user 12 may explore, and with which the user 12 may interact in the web browser user interface. The webpage and/or the elements on which the webpage depends may have markup source, such as, for example, HTML, xHTML, XML and/or the like; text; graphics; active content objects, scripts and/or applications, such as, for example, Flash (trademark of Adobe System, Inc.), Flash Actionscript, JavaScript (trademark of Sun Microsystems, Inc.), ECMAscript, VBScript and/or the like; and/or media content.

The web browser may allow the user 12 to find and/or render the internet media content objects in the rendered webpage and perform other functions which may be specifically enabled by the webpage and/or the scripts, the active content objects and/or the applications which may be embedded in the webpage. The web browser may allow the user to download the internet media content objects to a local media library, a local media server and/or another local storage location so that the user may use the internet media content objects outside of the web browser. After the internet media content is downloaded and saved to a local media library, the user may execute a separate media management application to access a local copy of the internet media content in the media library and/or to use any enhanced media functions provided by the media management application as previously set forth.

FIG. 2 generally illustrates a prior art system 30 for which a browser terminal 31 having an enhanced web browser (hereafter “the enhanced browser terminal 31”) is located in a local network 32. One or more local media sources 33 (hereafter “the local media sources 33”) may reside in and/or may be connected to the local network 32. Each of the local media sources 33 may be a media server and/or a local file store, and the media server may be compliant with UPnP AudioVisual and/or DLNA standards. Each of the local media sources 33 may be combined with the enhanced browser terminal 31 or may reside on a separate device.

Rendering devices 40 may be located in the local network 32. Media files from the local media sources 33 and/or from the internet media content websites 20 may be sent to the rendering devices 40. Each of the rendering devices 40 may be compliant with UPnP AudioVisual and/or DLNA home networking standards. For example, each of the rendering devices 40 may be a stereo, a television, a photo frame, a portable device and/or the like. Each of the rendering devices 40 may be intrinsic to a hardware device, such as a DLNA-compliant television, or may be implemented as rendering software executed by a laptop computer, a desktop computer, a mobile device and/or the like.

The local network 32 may have one or more control points which allow the user 12 to select multimedia content from an available content source and send the selected multimedia content to one or more of the rendering devices 40 for playback. A control point may be a UPnP AudioVisual compliant control point and/or a DLNA-compliant control point. One or more of the rendering devices 40 may have a built-in control point; for example, a DLNA-compliant television may have an embedded control point so that the user 12 may use the television user interface to browse and select multimedia content to be played on the television. Other devices may implement control points; for example, a mobile device, a desktop computer, a laptop computer and/or a dedicated media remote control device may implement a control point.

An enhanced web browser or a browser plug-in on the enhanced browser terminal 31 may provide control point functionality. The user 12 may discover internet media content objects in retrieved webpages using an enhanced web browser which may detect the internet media content objects. The enhanced web browser may have enhanced capabilities to manage and use the internet media content objects which are detected. Enhanced browser functions may be built into a web browser or may be added to the web browser as a browser plug-in. The enhanced browser functions may allow the user 12 to redirect the internet media content objects to one or more of the rendering devices 40 in the local network 32, to store the internet media content objects in the local media sources 33, to organize and/or manage the internet media content objects, and/or the like.

However, the enhanced web browser which enables such enhanced functionalities typically requires that the user obtains and installs the enhanced web browser on the browser terminal device to establish the enhanced browser terminal 31. Alternatively, the user 12 may establish the enhanced browser terminal 31 by obtaining and installing a browser plug-in to enhance the web browser already present on the browser terminal device. Thus, the enhanced browser functionality may not be available for all of a user's devices because typically some devices do not support software installation and some web browsers do not support a browser plug-in architecture. Further, a software company must use expense and effort to develop the enhanced web browser and/or the browser plug-in for multiple platforms and devices. Still further, installing and updating the enhanced web browser and/or the browser plug-in on the user's devices requires additional effort by the user.

For example, a user may have a desktop computer, a laptop computer, a tablet computer, a mobile phone and a gaming device. Each of these devices may have a web browser, and installing and updating the enhanced web browser or the browser plug-in on these devices may be difficult. Failure to install and update the enhanced web browser or the browser plug-in on these devices results in the enhanced functionality not being available on the devices which the user may use for web browsing. Thus, the web browsing capabilities will be inconsistent between the devices of the user.

For example, the user 12 may be browsing web content on a portable gaming device which has a standard web browser which lacks the enhanced browser functions, and the user 12 may discover internet media content objects using the gaming device. The user 12 may desire to redirect the internet media content objects to a larger rendering device in the home network. However, the standard web browser of the portable gaming device does not support such functionality. To complete the desired action, the user 12 may have to switch from the portable gaming device to a second device which supports the enhanced browser functions including redirection of internet media content to a rendering device. The user 12 may then be required to search again to find the same internet media content objects on the enhanced web browser of the second device before being able to redirect the internet media content objects to the desired rendering device in the local network 32. In general, different enhanced browsing functions on different devices do not provide a satisfactory multimedia experience.

Other enhanced browser functions, such as storing the internet media content objects to a local media server, organizing the internet media content objects, adding the internet media content objects to a list of favorite media content objects, and/or the like, have similar limitations with respect to the enhanced functionality not being available on all devices which the user may use for web browsing.

Most standard web browsers provide organization functionality and capabilities to add the internet media content objects to a list of favorite media content objects, but the resulting organization and/or the resulting favorites list is limited to the specific web browser. Thus, a user moving from a first device with a first web browser to a second device with a second web browser encounters different “favorites” lists because the lists are maintained and stored locally to each of the web browsers. Thus, a user with multiple devices capable of web browsing does not obtain the benefit of a single, consistent personal list of favorite media content objects as the user moves from one device to another device.

Because the enhanced web browser may be actively detecting and/or identifying internet media content objects in the retrieved webpages, the content provider, such as the owner or operator of an internet media content website, may not control how the internet media content objects are used by the enhanced web browser. For example, a content provider may wish to allow some internet media content objects available from the provider's content website to be redirected to rendering devices in a home network. However, the content provider may wish to prohibit this functionality for other internet media content objects available from the provider's content website.

In prior art systems, a content provider cannot select which enhanced browsing functions are enabled for which internet multimedia content. Moreover, the content provider cannot be aware that these enhanced browser functions, such as media redirection, downloading to local storage, organization, adding to a list of favorite media content objects, and/or the like, are being performed on the provider's internet media content objects. These functions are carried out entirely by the enhanced web browser within the enhanced browser terminal 31.

### SUMMARY OF THE INVENTION

The present invention generally relates to a system and a method for embedding multimedia controls and indications in a webpage which may provide access to internet media content. More specifically, the multimedia controls and indications embedded in the webpage may be accessible using a standard web browser and may enable a user of the standard web browser to invoke enhanced media functions for internet media content objects available through the webpage.

The enhanced browser functions may include redirection of the internet media content to a rendering device in a home network, and the rendering device may be a different device than the browser terminal. The enhanced browser functions may include the ability to download the internet media content to a media server or other local storage device in the network, and the media server and the other local storage device may each be a different device than the browser terminal.

To this end, in an embodiment, a method for embedding multimedia controls and indications in a webpage is provided. The webpage has controls associated with multimedia content objects that are accessible via the internet. The method has the step of associating a first control with a first multimedia content object. The method also has the step of using a first device in a local network to retrieve the webpage and the controls from a web server located outside of the local network. The method also has the step of displaying the webpage and the controls on the first device to a user. The method has the step of invoking the first control using the first device. A user invokes the first control. The method has the step of sending a message from the first device to a second device in the local network in response to the user invoking the first control. The method also has the step of sending a communication from the second device to a rendering device in the local network in response to the message. Finally, the method has the step of rendering the first multimedia content object on the rendering device in response to the communication.

In an embodiment, the first control is a link that points to a local address of the second device within the local area network.

In an embodiment, the first control is displayed by an active element of the webpage.

In an embodiment, the web server is operated by a content provider and wherein the content provider inserts the controls into the webpage.

In an embodiment, the web server is a proxy server that retrieves the webpage from a content provider web site, inserts the controls into the webpage, and provides the webpage and the controls to the first device.

In an embodiment, the method has the step of providing a registration server located outside of the local network. The second device registers with the registration server, and the registration server associates the registration with a network ID that identifies the local network.

In an embodiment, the first device has a standard web browser that is used to display the webpage to the user.

In an embodiment, the second device controls rendering of the first internet multimedia content object on the rendering device.

In an embodiment, the second device transmits a report that specifies the internet multimedia content objects that the second device caused to be rendered using the rendering device and wherein information from the report is delivered to a content provider that provided the webpage.

In another embodiment, a system for embedding multimedia controls and indications in a webpage is provided. The webpage has controls associated with multimedia content objects that are accessible via the internet. The system has a first control associated with a first multimedia content object. The system also has a first device in a local network. The first device retrieves the webpage and the controls from a web server located outside of the local network and displays the webpage and the controls to a user. The user invokes the first control using the first device. The system also has a second device in the local network. The first device sends a message to the second device in response to the user invoking the first control. Finally, the system has a rendering device in the local network. The second device communicates with the rendering device in response to the message, and the rendering device renders the first multimedia content object in response to the communication.

In an embodiment, the second device transmits a report that specifies the internet multimedia content objects that the second device caused to be rendered using the rendering device. The information from the report is delivered to a content provider that provided the webpage.

In an embodiment, the first control is a link that points to a local address of the second device within the local area network.

In an embodiment, the first control is displayed by an active element of the webpage.

In an embodiment, the web server is operated by a content provider. The content provider inserts the controls into the webpage.

In an embodiment, the web server is a proxy server that retrieves the webpage from a content provider web site, inserts the controls into the webpage, and provides the webpage and the controls to the first device.

In an embodiment, the system also has a registration server located outside of the local network. The second device registers with the registration server, and the registration server associates the registration with a network ID that identifies the local network.

In an embodiment, the first device has a standard web browser that is used to display the webpage to the user.

In an embodiment, the second device controls rendering of the first internet multimedia content object on the rendering device.

In a further embodiment, method for embedding multimedia controls and indications in a webpage is provided. The webpage has controls associated with multimedia content objects that are accessible via the internet. The method has the step of providing a first device in a local network connected to the internet. The method has the step of sending a registration message from the first device to a registration server via the internet. The method also has the step of processing the registration message with the registration server to determine a first network ID that identifies the local network in which the first device resides and a local address of the first device within the local network. Also, the method has the step of storing the first network ID and the local address of the first device in a registration record associated with the first device on the registration server. Further, the method has the step of sending a request message from a second device to a web server via the internet. The method also has the step of processing the request message with the web server to determine a second network ID that identifies the local network in which the second device resides. Also, the method has the step of querying the registration server with the web server using the second network ID wherein the registration server determines that the second network ID matches the first network ID and the registration server returns the local address of the first device to the web server in response to the query. Finally, the method has the step of returning a webpage to the second device from the web server in response to the request message. The webpage has controls, and invocation of the controls by a user of the second device causes the second device to communicate with the first device using the local address of the first device.

In an embodiment, the network ID is added to the registration message by a third device. The third device connects the local network to the internet.

In an embodiment, the network ID is added to the request message by a third device. The third device connects the local network to the internet.

In an embodiment, the network ID is a globally routable IP address associated with the local network.

In an embodiment, the registration server and the web server are combined into one device.

In an embodiment, the web server is a proxy server through which the second device obtains webpages from the internet.

In an embodiment, the web server generates the controls using the local address of the first device as obtained from the registration server. The web server inserts the controls into the webpage before returning the webpage to the second device.

In an embodiment, the registration message identifies a rendering device in the local network. The first device and the rendering device are different devices.

In yet another embodiment, a method for embedding multimedia controls and indications in a webpage is provided. The webpage has controls associated with multimedia content objects that are accessible via the internet. The method has the step of transmitting a request message from a first device to a proxy server wherein the request message requests a webpage. The method also has the step of retrieving the webpage from a remote web server via the internet using the proxy server. The method has the step of inserting controls into the webpage using the proxy server. The controls are associated with internet multimedia content objects accessible using the webpage. A first control is associated with a first internet multimedia content object. The method also has the step of providing the webpage and the controls from the proxy server to the first device in response to the request message. Also, the method has the step of displaying the webpage and the controls to a user of the first device using a web browser on the first device. The user invokes the first control using the web browser on the first device. Finally, the method has the step of transmitting a message from the web browser to a second device in response to the user invoking the first control. The message identifies the first multimedia content object.

In an embodiment, the first device is in a local network and the proxy server is outside the local network and accessible to the first device via the internet.

In an embodiment, the first device and the proxy server are located in the same local network.

In an embodiment, the first device and the second device are two different devices in the same local network.

In an embodiment, the first device and the second device are two different devices in a local network. The proxy server queries a registration server to obtain the local address of the second device in the local network. The proxy server generates the first control using the local address of the second device.

In an embodiment, the second device communicates with a rendering device in response to the message. The communication causes the rendering device to retrieve the first internet multimedia content object. The communication also causes the rendering device to render the first internet multimedia content object. The first device, the second device and the rendering device are different devices.

In an embodiment, the second device causes the first internet multimedia content object to be downloaded and stored in a local network in response to the message. The first device and the second device are different devices.

In an embodiment, the second device adds the first internet multimedia content object to a list of favorites associated with a user of the first device in response to the message.

In an embodiment, the first control is part of an active element inserted into the webpage by the proxy server.

In still another embodiment, a system for embedding multimedia controls and indications in a webpage is provided. The webpage has controls associated with multimedia content objects that are accessible via the internet. The system also has a webpage that provides access to internet multimedia content objects. The system has an active element executed by the web browser. The active element analyzes the webpage and displays controls in the webpage. The controls are associated with the internet multimedia content objects. The system also has a webpage source separate from the active element. The webpage source includes links to the internet multimedia content objects. Further, the system has markup text in the webpage source. The markup text indicates for each of the internet multimedia content objects whether the internet multimedia content object is allowed to be redirected to a rendering device. The active element displays a redirection control for a first internet multimedia content object if the markup text indicates that the first internet multimedia content object is allowed to be redirected to a rendering device.

In an embodiment, a content provider provides the webpage and inserts the markup text into the webpage source to indicate media functions that are allowed or disallowed for each internet multimedia content object accessible through the webpage.

In an embodiment, a service provider provides the active element as a package available on a web server and a content provider provides the webpage. The content provider incorporates the active element into the webpage by reference using a URL.

In an embodiment, the system also has a proxy server that retrieves the webpage source and the markup text from a web server in response to a request from the web browser. The proxy server inserts the active element into the webpage and transmits the webpage to the web browser in response to the request.

In an embodiment, the active element parses the markup text by traversing a document object model of the webpage.

It is, therefore, an advantage of the present invention to provide a system and a method for embedding multimedia controls and indications in a webpage so that the multimedia controls and indications embedded in the webpage may be accessible using a standard web browser and may enable a user of the standard web browser to invoke enhanced media functions for internet media content objects available through the webpage.

Another advantage of the present invention is to provide a system and a method for embedding multimedia controls and indications in a webpage which may enable enhanced media functions to be invoked without requiring internet media content objects to be downloaded or added to a local media library before invocation of the enhanced media functions.

And, another advantage of the present invention is to provide a system and a method for embedding multimedia controls and indications in a webpage which may provide a consistent user experience for enhanced media functions across various internet media content websites.

A further advantage of the present invention is to provide a system and a method for embedding multimedia controls and indications in a webpage where the embedded multimedia controls and indications may be used to redirect an internet media content object accessible through the webpage to rendering devices in a home network.

Another advantage of the present invention is to provide a system and a method for embedding multimedia controls and indications in a webpage where one of the embedded multimedia controls and indications may be invoked to add and/or include an internet media content object accessible through the webpage in a playlist.

Yet another advantage of the present invention is to provide a system and a method for embedding multimedia controls and indications in a webpage where one of the embedded multimedia controls and indications may be invoked to add an internet media content object accessible through the webpage to a list of favorite media content objects. A further advantage of the present invention is to provide a system and a method for embedding multimedia controls and indications in a webpage where the embedded multimedia controls and indications may enable tracking of a history of internet media content objects accessed and/or used by the user.

Another advantage of the present invention is to provide a system and a method for embedding multimedia controls and indications in a webpage where one of the embedded controls and indications may be invoked to download and/or add an internet media content object accessible through the webpage to a local media library.

Yet another advantage of the present invention is to provide a system and a method for embedding multimedia controls and indications in a webpage where one of the embedded multimedia controls and indications may be invoked to add and/or include an internet media content object accessible through the webpage to a playlist which includes a mixture of internet media content objects and media content objects from a local media library and/or a local media server.

Another advantage of the present invention is to provide a system and a method for embedding multimedia controls and indications in a webpage where one of the embedded multimedia controls and indications may be invoked to add and/or include an internet media content object accessible through the webpage to a playlist which may be accessed and may be managed from different web browsers on multiple devices.

And, another advantage of the present invention is to provide a system and a method for embedding multimedia controls and indications in a webpage where one of the embedded multimedia controls and indications may be invoked to add an internet media content object accessible through the webpage to a list of favorite media content objects which may be accessed and may be managed from different web browsers on multiple devices.

Yet another advantage of the present invention is to provide a system and a method for embedding multimedia controls and indications in a webpage where the embedded multimedia controls and indications may enable tracking of a history of internet media content objects accessed and/or used by the user which may be accessed and may be managed from different web browsers on multiple devices.

A further advantage of the present invention is to provide a system and a method for embedding multimedia controls and indications in a webpage where a proxy server may detect internet media content objects accessible through the webpage and then may embed the multimedia controls and indications in the webpage.

Another advantage of the present invention is to provide a system and a method for embedding multimedia controls and indications in a webpage in which a content provider may embed the controls and indications in webpages provided by the content provider to enable enhanced media functions for internet media content objects accessible through the webpage which are selected by the content provider.

And, another advantage of the present invention is to provide a system and a method for embedding multimedia controls and indications in a webpage where the content provider may embed the controls and indications in the webpages by inserting a script in the webpages, and an entity other than the content provider may provide the script.

Another advantage of the present invention is to provide a system and a method for embedding multimedia controls and indications in a webpage where the embedded multimedia controls and indications may interact with a personalization server accessible over the internet to provide at least some of the enhanced media functions provided by the embedded multimedia controls and indications.

Yet another advantage of the present invention is to provide a system and a method for embedding multimedia controls and indications in a webpage where the embedded multimedia controls and indications may interact with a control agent in the local network to provide at least some of the enhanced media functions provided by the embedded multimedia controls and indications.

A further advantage of the present invention is to provide a system and a method for embedding multimedia controls and indications in a webpage where the embedded multimedia controls and indications may interact with a control agent in the local network to provide at least some of the enhanced media functions provided by the embedded multimedia controls and indications, where the control agent in the local network registers with an entity outside the local network, and the registration enables the embedded multimedia controls and indications to discover and/or interact with the control agent.

Another advantage of the present invention is to provide a system and a method for embedding multimedia controls and indications in a webpage where invocation of the embedded multimedia controls and indications may be communicated to a local entity to provide enhanced browser functions.

Yet another advantage of the present invention is to provide a system and a method for embedding multimedia controls and indications in a webpage which may enhance the functions present in the webpage.

A further advantage of the present invention is to provide a system and a method for embedding multimedia controls and indications in a webpage which may provide a separate control area in the webpage to identify and provide enhanced control over the aggregate list of internet media content objects accessible through the webpage.

Another advantage of the present invention is to provide a system and a method for embedding multimedia controls and indications in a webpage which may visually identify internet media content objects accessible through the webpage so that the visual identifications may be seen using a standard web browser without a special web browser or browser plug-in.

Yet another advantage of the present invention is to provide a system and a method for embedding multimedia controls and indications in a webpage which may redirect internet media content objects accessible through the webpage to a rendering device a home network using a standard web browser without leaving the web browser for a separate media management application.

Another advantage of the present invention is to provide a system and a method for embedding multimedia controls and indications in a webpage which may use an active element to analyze the webpage so that the invocation of the controls and indications is communicated to an entity outside the home network to provide enhanced browser functions.

And, another advantage of the present invention is to provide a system and a method for embedding multimedia controls and indications in a webpage which may use an active element to analyze the webpage so that the invocation of the controls and indications is communicated to a control agent in the home network to provide enhanced browser functions.

Yet another advantage of the present invention is to provide a system and a method for embedding multimedia controls and indications in a webpage for which a content provider may enable or disable an enhanced browser function for each of the internet media content objects accessible through the webpage.

A further advantage of the present invention is to provide a system and a method for embedding multimedia controls and indications in a webpage where a package of the controls and indications are provided to an internet media content website provider which embeds the package of the controls and indications in the webpage.

Another advantage of the present invention is to provide a system and a method for embedding multimedia controls and indications in a webpage for which a content provider may enable or disable an enhanced browser function for each of the internet media content objects accessible through the webpage by marking up the webpage.

And, another advantage of the present invention is to provide a system and a method for embedding multimedia controls and indications in a webpage for which a first device in a home network registers with a registration server outside of the home network so that invocation of the controls and indications on a second device in the home network is communicated to the first device.

Another advantage of the present invention is to provide a system and a method for embedding multimedia controls and indications in a webpage for which a first device in a home network registers with a registration server outside of the home network so that invocation of the controls and indications on a second device in the home network is communicated to the first device, and the controls and indications are embedded by a proxy server which obtained information about the first device from the registration server.

Yet another advantage of the present invention is to provide a system and a method for embedding multimedia controls and indications in a webpage for which a first device in a home network registers with a registration server outside of the home network so that invocation of the controls and indications on a second device in the home network is communicated to the first device, and the controls and indications are embedded by the provider of the webpage which obtained information about the first device from the registration server.

A further advantage of the present invention is to provide a system and a method for embedding multimedia controls and indications in a webpage for which a first device in a home network registers with a registration server outside of the home network so that invocation of the controls and indications on a second device in the home network is communicated to the first device, and invocation of the controls and indications on the second device queries the registration server for information about the first device.

Another advantage of the present invention is to provide a system and a method for embedding multimedia controls and indications in a webpage for which a first device in a home network registers with a registration server outside of the home network so that invocation of the controls and indications on a second device in the home network is communicated to the first device, and the first device is discovered by matching a network identifier which identifies the local network.

Additional features and advantages of the present invention are described in, and will be apparent from, the detailed description of the presently preferred embodiments and from the drawings.

### BRIEF DESCRIPTION OF THE DRAWINGS

FIGS. 1 and 2 illustrate black box diagrams of prior art systems for accessing and using internet media content.

FIGS. 3 and 7 illustrate black box diagrams of systems for embedding multimedia controls and indications in a webpage which may provide access to internet media content in embodiments of the present invention.

FIGS. 4-6 and 8-11 illustrate examples of webpages which may be implemented in embodiments of the present invention.

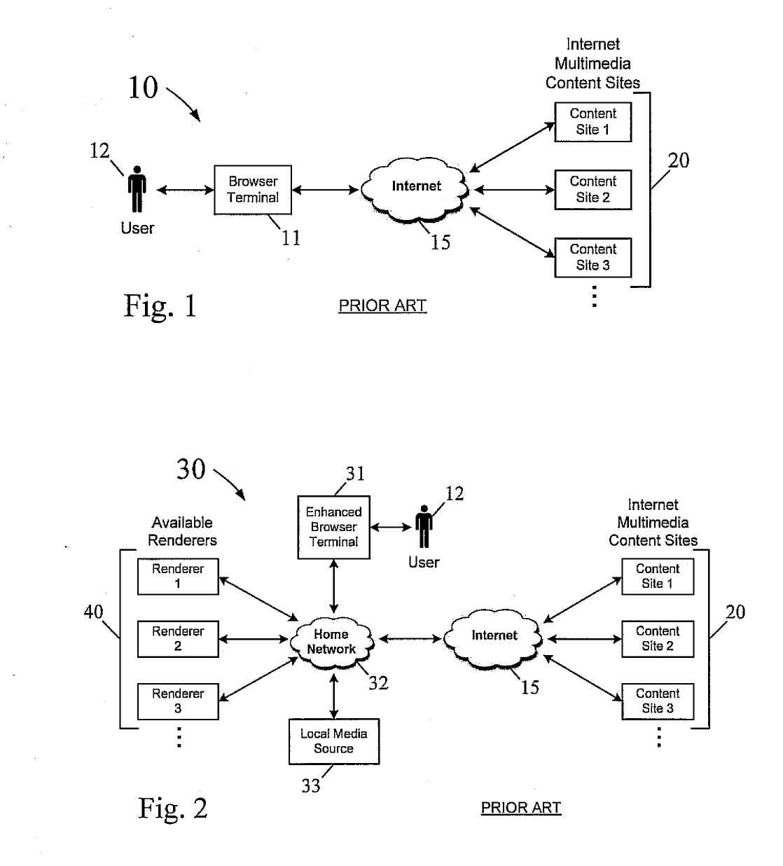

### DETAILED DESCRIPTION OF THE PREFERRED EMBODIMENTS

The present invention generally relates to a system and a method for embedding multimedia controls and indications in a webpage which may provide access to internet media content objects. More specifically, the multimedia controls and indications embedded in the webpage may be accessible using a standard web browser and may enable a user of the standard web browser to invoke enhanced media functions for internet media content objects available through the webpage.

The enhanced browser functions may include redirection of the internet media content objects to a rendering device in a home network, and the rendering device may be a different device than the browser terminal. The enhanced browser functions may include downloading the internet media content objects to a media server or other local storage device in the network, and the media server and the other local storage device may each be a different device than the browser terminal.

The enhanced browser functions may include organizing the internet media content objects, to add the internet media content objects to a list of favorite media content objects, adding the internet media content objects to a playlist, and/or tracking a history of internet media content objects accessed and/or used by the user. The resulting media organization, the resulting list of favorite media content objects, the resulting playlist, and/or the resulting history may be accessible to the user from any standard web browser available on any device.

In some embodiments, the controls and indications may be embedded in the webpage by a content provider who provides the webpage. The content provider may own and/or may operate an internet media content website which provides the webpage to provide access to internet media content. The content provider may own the internet media content objects and/or may be a distributor for the internet media content objects. The content provider may specify that the enhanced browser functions are allowed for and/or applicable to one or more of the multimedia content objects accessible through the webpage.

The controls and indications may enable the content provider to specify that the enhanced browser functions are not allowed for and/or not applicable to one or more of the internet media content objects accessible through the webpage. More generally, the controls and indications may enable the content provider to specify which functions of a plurality of available enhanced browser functions are allowed for and/or are applicable to each of the internet media content objects accessible through the one or more webpages which form an internet media content website.

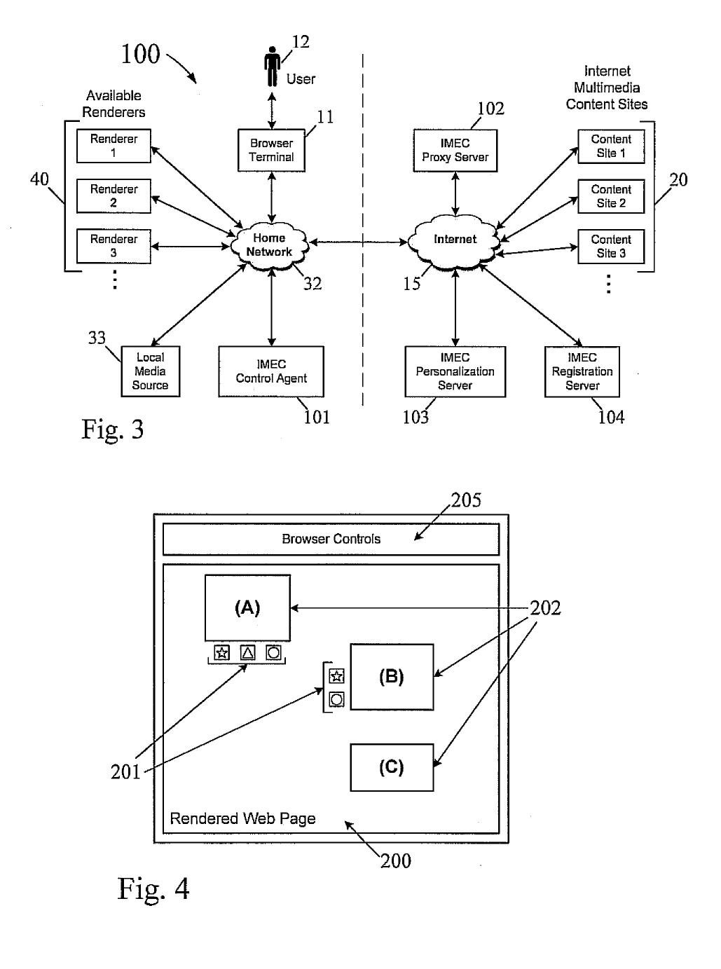

FIG. 3 generally illustrates a network configuration 100 in which an embodiment of the present invention may operate. Controls and indications may be embedded in the webpage by a proxy server 102 which may receive the webpage destined for the browser terminal 11. The proxy server 102 may analyze the webpage to discover and/or detect the internet media content objects accessible through the webpage, may modify the webpage to insert the controls and indications, and may transmit the modified webpage to the browser terminal 11.

The proxy server 102 may be present in the same local network 32 as the browser terminal 11; for example, the proxy server 102 and the browser terminal 11 may reside in the same local network 32. For example, the proxy server 102 may reside in a router or a network hub in the local network 32 or may be a software proxy running on a personal computer in the local network 32. Alternatively, as generally illustrated in the example depicted in FIG. 3, the proxy server 102 may be located outside of the local network 32 and/or may be accessible to the browser terminal over the internet 15. In an embodiment, the local network 32 may be a local area network and/or a home network.

The controls and indications may enable the user 12 to access the enhanced browser functions using a standard web browser and additional networked components, such as a control agent 101 and/or a personalization server 103, each discussed in more detail hereafter. The controls and indications may interact with the additional networked components to provide the enhanced browser functions. Hereafter, “the user 12” is used to refer to a user currently using the browser terminal 11, and the present invention is not limited to a specific number of users. The present invention may support any number of users, and different personalization records may be associated with each of the users as discussed in further detail hereafter.

For the present invention, the web browser may be a standard web browser in that the web browser does not require any special enhancements to enable the enhanced browser functions disclosed herein. The enhancements may be provided and may be supported by other components accessible through a local network 32, such as a local area network and/or a home network, and/or a wide area network, such as the internet 15. These components may be the control agent 101, the proxy server 102, a personalization server 103 and/or a registration server 104 (collectively hereafter “the internet media enhancement components 101,102,103,104”).

A non-transitory computer-readable medium, such as, for example, register memory, processor cache and Random Access Memory (RAM), may have program instructions. Execution of the program instructions by the browser terminal 11 and/or one or more of the internet media enhancement components 101,102,103,104 may cause the browser terminal 11 and/or one or more of the internet media enhancement components 101,102,103,104 to perform one or more of the steps disclosed herein. The non-transitory computer-readable medium may be any computer-readable medium with the sole exception being a transitory, propagating signal.

One or more of the internet media enhancement components 101,102,103,104 may be absent in an embodiment. For example, the controls and indications which enable the enhanced browser functions may be embedded in the webpage by a content provider. As another example, the controls and indications which enable the enhanced browser functions may be embedded in the webpage by the proxy server 102 which may process the webpage traveling from one of the internet media content websites 20 to the browser terminal 11. Thus, some embodiments of the present invention require the proxy server 102, and some embodiments of the present invention do not require the proxy server 102.

The personalization server 103 may store media organization associated with a user, lists of favorite media content objects associated with a user, playlists associated with a user, and/or a history of media content objects accessed and/or used by a user (collectively hereafter “personalization records”). The personalization server 103 may support social media functions, such as, for example, media recommendations and/or sharing. Thus, embodiments of the present invention which store personalization records and/or support social media functions may have the personalization server 103. However, embodiments of the present invention may not have the personalization server 103; for example, in an embodiment, the only enhanced browser function may be redirection of an internet media content object to one or more of the rendering devices 40, and such an embodiment may not have the personalization server 103.

Each of the rendering devices 40 may be a stereo, a television, a photo frame, a portable device, a gaming device, a PC, a laptop computer, and/or the like. Each of the rendering devices 40 may be intrinsic to a hardware device, such as a DLNA-compliant television, or may be implemented as rendering software executed by a laptop computer, a desktop computer, a mobile device and/or the like. The present invention is not limited to a specific embodiment of the rendering devices 40, and each of the rendering devices 40 may be any device capable of rendering and/or playing a media content object.

The control agent 101, if present, may reside in the same local network 32, such as a local area network and/or a home network, as the browser terminal 11. The control agent 101 may support the enhanced browser functions which involve other devices in the local network 32, namely devices in the local network 32 other than the browser terminal 11. The control agent 101 may support redirection of an internet media content object to one or more of the rendering devices 40 in the local network 32.

The control agent 101 may support downloading and/or storing an internet media content object to the local media sources 33. Some embodiments of the present invention may not have the control agent 101. For example, an embodiment may lack the control agent 101 but may use the personalization server 103 to enable enhanced browser functions, such as media organization; creating, using and/or organizing playlists, lists of favorite media content, and/or a history of media content objects accessed and/or used by the user; sharing media content objects; and/or the like.

Some embodiments of the present invention may have all of the internet media enhancement components 101,102,103,104. As a result, such an embodiment may enable all of the enhanced browser functions disclosed herein.

The user 12 may use a web browser available on the browser terminal 11. As previously set forth, the browser terminal 11 may be any device capable of running a web browser or otherwise providing web browsing capabilities. For example, the browser terminal 11 may be a desktop computer, a laptop computer, a gaming console, a portable gaming device, a portable media player, a PDA, a mobile phone, a tablet computer, and/or the like. The present invention is not limited to a specific embodiment of the browser terminal 11, and the browser terminal 11 may be any device which has a web browser.

The web browser may be built into the browser terminal and/or may be part of the operating system of the browser terminal 11. Alternatively, the web browser may be an application installed by the user 12 onto the browser terminal 11.

The web browser may be any web browser which supports standard web browsing operations. For example, the web browser may allow the user 12 to enter a URL in a text box to navigate to the webpage indicated by the URL. The web browser may allow the user 12 to navigate back to a previously visited webpage and/or to navigate to a homepage set by the user 12. The web browser may use HTTP requests, such as a GET request, to request and to retrieve webpages from the internet 15. The web browser may interpret the various content types, scripts and markup languages which form the content of the webpage to display the webpage to the user 12. The web browser may enable the user 12 to interact with the webpage; for example, the web browser may enable the user 12 to select a link in the webpage to navigate to a new webpage associated with the link. The web browser may run active elements, such as scripts present in the webpage, and may enable the user 12 to interact with such scripts through user interface controls presented by the scripts. The web browser may enable the user 12 to access internet media content objects through the webpage. These web browser functions and other web browser functions are well-known in the art; the web browser may be any web browser known to one skilled in the art.

References in the present disclosure to a “standard web browser” refer to any browser capable of standard web browsing operations, as known to one skilled in the art. Such a web browser may have additional enhancements beyond what one skilled in the art would consider “standard.” However, such enhancements do not disqualify a web browser from being a “standard web browser” for purposes of the present invention. In most embodiments, no such browser enhancements are required for operation of the present invention.

The webpage may be composed of markup source, active scripts, text, graphics, formatting, links, and/or the like. The markup source may be, for example, HTML, xHTML, XML, and/or the like. The active scripts may be for example, Flash (trademark of Adobe), Flash actionscript, JavaScript (trademark of Sun Microsystems), ECMAscript, VBScript, and/or the like.

The webpage may contain and/or may provide access to internet media content objects. The internet media content objects may be and/or may include image content objects, such as, for example, digital photographs, graphic images, bitmap images, vector graphics, animated image files and/or the like; audio content objects, such as, for example, digital audio files, music files, synthetic music files, encoded speech, audio podcast, audio streams, internet radio channels, ringtones, midi files and/or the like; and/or video content objects, such as, for example, video files, video clips, video podcasts, video streams, video channels, TV shows, movies, user-generated video and/or the like.

The browser terminal 11 may be connected to the internet 15 by a network, such as a local area network and/or a home network. In an embodiment, the browser terminal 11 may be connected to the internet 15 by the local network 32. The network connecting the browser terminal 11 to the internet 15 may have connections that are wired or wireless. For example, the network connecting the browser terminal 11 to the internet 15 may be based on one or more of the following technologies: Ethernet/wired LAN, IEEE 1394 (“Fire Wire”) and/or IEEE 802.11 (“WiFi”). The network connecting the browser terminal 11 to the internet 15 may utilize other technologies not listed herein. The present invention is not limited to a specific embodiment of the network connecting the browser terminal 11 to the internet 15.

The local network 32 may have and/or may be connected to the rendering devices 40 which are devices capable of rendering media content. Each of the rendering devices 40 may be and/or may include one or more of the following devices: a networked television, a networked stereo, a networked photo rendering device known as a “digital photo frame,” a desktop computer, a laptop computer, a tablet computer, a gaming device, a PDA, a mobile phone, a portable media player device, and/or the like. Each of the rendering devices 40 may be compliant with home network multimedia standards, such as UPnP AV and/or DLNA.

The local network 32 may be connected to the local media sources 33 which may be devices capable of storing media content objects and/or providing access to the stored media content objects. For example, each of the local media sources 33 may be a media server, a network-attached storage device, a personal computer which stores media content objects on an internal hard drive, a mobile phone which stores digital photos and video files captured by a camera of the mobile phone, and/or the like. Each of the local media sources 33 may be a UPnP AV Media Server and/or a DLNA-compliant media server. The stored media content objects may be and/or may include, for example, music tracks transferred from compact discs, music tracks purchased from an internet music store, video files captured using a camcorder device, digital photographs, audio and/or visual files downloaded from the internet 15, and/or the like.

The user 12 may use the web browser on the browser terminal 11 to access webpages and/or internet media content objects available from one or more of the internet media content websites 20. Three of the internet media content websites 20 are depicted in FIG. 3; however, any number of the internet media content websites 20 may be available.

Each of the internet media content websites 20 may be, for example, a video sharing website, a news website, a sports website, an online magazine, an online music website, a digital photo sharing website, a social networking website, a digital encyclopedia, a corporate website, a school website, and/or the like. Each of the internet media content websites 20 may be any website which includes, presents, and/or provides access to multimedia content over the internet 15. The present invention is not limited to a specific embodiment of the internet media content websites 20.

At the direction of the user 12, the web browser may send a request to one of the internet media content websites 20 for a webpage and/or an internet media content object accessible through the webpage. In response, the internet media content website 20 which receives the request may transmit the webpage and/or the internet media content object to the web browser on the browser terminal 11. The webpage and/or the internet media content object may be delivered to the browser terminal 11 over the internet 15 and/or the local network 32. In some embodiments, the webpage and/or the internet media content object may be delivered through the proxy server 102. If present, the proxy server 102 may analyze and/or may alter the webpage and/or the internet media content object as discussed in further detail hereafter.

The webpage may have controls and/or indications which support enhanced browser functions. The controls and/or indications may be embedded in the webpage by the internet media content website 20 to enable and/or support the enhanced browser functions. Alternatively or additionally, the controls and/or indications may be added to the webpage by the proxy server 102 as discussed in further detail hereafter.

The indications may indicate whether one or more of the enhanced browser functions are allowed for and/or applicable to each of the multimedia content objects accessible from the webpage. For example, the indications may indicate that a first multimedia content object may be redirected to one or more of the rendering devices 40 in the local network 32, that a second multimedia content object may be downloaded and stored to the local media sources 33, and that a third multimedia content object may not be redirected to one of the rendering devices 40 in the local network 32 or downloaded to the local media sources 33. Each of the indications may be positive, namely allowing a specific enhanced browser function, or negative, namely disallowing a specific enhanced browser function. Moreover, the absence of an indication may indicate that one or more of the enhanced browser functions are not allowed for an internet media content object.

Therefore, the user 12 may use the web browser on the browser terminal 11 to request a webpage from one of the internet media content websites, and, as a result, the web browser may retrieve, may obtain and/or may display the webpage. The webpage may include the controls and/or the indications which may have been added to the webpage by the internet media content website 20 and/or by the proxy server 102. The web browser may display the controls and/or the indications in the webpage and may enable the user 12 to interact with the controls and/or the indications to invoke the enhanced browser functions. In response, invocation of the controls and/or the indications may be communicated to the control agent 101 and/or the personalization server 103 to implement and/or control the enhanced browser functions.

FIG. 4 generally illustrates a webpage 200 rendered by the web browser on the browser terminal 11. The web browser may present standard browser controls 205 which allow the user to select, navigate to and/or request the webpage 200. The webpage 200 may have controls and/or indications 201 (hereafter “controls/indications 201”) to enable the enhanced browser functions disclosed herein. The webpage 200 may be rendered in a standard web browser.

FIG. 4 depicts internet media content objects 202 in the webpage 200 with the controls/indications 201 which were added to the content of the webpage 200. As shown in the depicted example, the controls/indications 201 may be positioned proximate to the in-page representation of the internet media content objects 202, such as, for example, overlaid on, directly below, directly above, and/or directly to the side of the in-page representation of corresponding internet media content object 202.

For example, the internet media content website 20 which provided the webpage 200 may have positioned the controls/indications 201 for each of the internet media content objects 202 in the webpage 200 proximate to the in-page representation of the corresponding multimedia content object 202. As another example, the proxy server 102 may have analyzed the webpage 200 to identify the internet media content objects 202. Then, the proxy server 102 may have added the controls/indications 201 for each of the internet media content objects 202 in the webpage 200 at a position proximate to the in-page representation of the corresponding multimedia content object 202.

The controls/indications 201 may be and/or may include links which may be selected, may be clicked and/or may be invoked by the user 12. The links may be visibly represented as text, graphic icons, buttons, images and/or the like. The links may have URLs which may direct to the control agent 101 and/or to the personalization server 103.

The user 12 may select, may click and/or may invoke one of the links, and, as a result, the web browser may send a message to the control agent 101 and/or to the personalization server 103. The message may be, for example, an HTTP GET request or an HTTP POST request. The message may identify one of the internet media content objects 202 accessible via the webpage 200. The message may identify an enhanced browser function corresponding to the control to which the link represents. The message may contain other information relevant to invoking and/or controlling an enhanced browser function for the internet media content object 202 identified by the message.

The identification of the internet media content object 202, the identification of the enhanced browser function, and/or the other information may be carried in the target URL of the link and/or may be carried elsewhere in the message. For example, the identification of the multimedia content object 202 and/or the identification of the enhanced browser function may be carried in one or more message headers. Alternatively or additionally, the identification of the internet media content object 202 and/or the identification of the enhanced browser function may be carried in the body of the message. For example, the identification of the internet media content object 202 and/or the identification of the enhanced browser function may be carried in an HTTP POST message body associated with the link.

The controls/indications 201 may be represented and/or presented using active elements of the webpage 200. For example, the controls/indications 201 may be displayed by Javascript, a Flash active object, and/or a similar active element within the webpage 200. The active element may include programming logic which may enable user interaction. For example, the active element may display a menu of options relevant to a corresponding internet media content object 202 when the user 12 places a pointer control, such as a pointer controlled by a mouse, in proximity of the corresponding internet media content object 202.

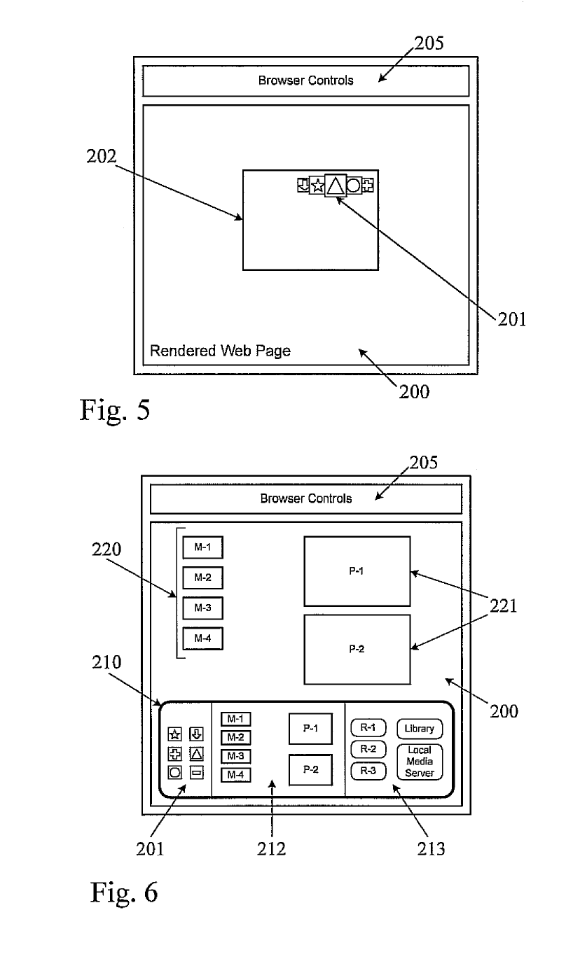

As another example, FIG. 5 generally illustrates the webpage 200 having a carousel of the controls/indications 201. The carousel of the controls/indications 201 may be presented and/or may be controlled by an active element of the webpage 200 to enable the enhanced browser functions for a corresponding internet media content object 202. The carousel of the controls/indications 201 may be overlaid on the corresponding internet media content object 202; however, the present invention is not limited to a specific position of the carousel of the controls/indications 201.

The user 12 may interact with the carousel of the controls/indications 201 to rotate the controls/indications 201 and/or specify a selected control/indication 201. As a result, the active element may communicate with the control agent 101 and/or the personalization server 103 to invoke and/or to control the enhanced browser function associated with the selected control/indication. The communication may identify the corresponding internet media content object 202 and/or the enhanced browser function. The communication may include other information relevant to invocation and/or control of the enhanced browser function. The communication may be based on HTTP; may be based on a remote procedure call method, such as SOAP; and/or may be based on another suitable messaging protocol. The present invention is not limited to a specific protocol used for the communication.

The controls/indications 201 may enable a different set of enhanced browser functions for each of the multimedia content objects 202 accessible through the webpage 200. For example, in the example depicted in FIG. 4, the controls/indications 201 may be illustrated using a star symbol, a triangle symbol and/or a circle symbol. As previously set forth, each of the controls/indications 201 may correspond to an enhanced browser function. For example, the star symbol may be a control which redirects the corresponding internet media content object 202 to one of the rendering devices 40 in the local network 32. The triangle symbol may be a control which stores the corresponding internet media content object 202 on one of the local media sources 33 in the local network 32. The circle symbol may be a control which adds the corresponding internet media content object 202 to a list of favorite media content objects.

Using these examples, the controls/indications 201 generally illustrated in FIG. 4 may enable the user 12 to redirect internet media content object A and internet media content object B to one of the rendering devices 40, store internet media content object A on one of the local media sources 33, and/or add internet media content object A and internet media content object B to the list of favorite media content objects. Internet media content object C is shown with none of the controls/indications 201 to indicate that none of the enhanced browser functions may be allowable for internet media content object C.

As a first example of use of the controls/indications 201, the user 12 may invoke the control/indication 201 represented by the star symbol adjacent to internet media content object A. As a result, the web browser may send a communication to the control agent 101, and the communication may identify internet media content object A and/or the corresponding enhanced browser function, such as redirection of internet media content object A to a target rendering device in the local network 32.

In response, the control agent 101 may take actions to begin rendering internet media content object A on the target rendering device in the local network 32. For example, the control agent 101 may communicate with the target rendering device to instruct the target rendering device to retrieve and render the internet media content object A from the internet media content website 20 which provides the internet media content object A. As another example, the control agent 101 may retrieve the internet media content object A from the internet media content website 20 which provides the internet media content object A, may transform the internet media content object A to a form suitable for rendering on the target rendering device, and/or may transmit the transformed version of the internet media content object A to the target rendering device for rendering.

Communication between the control agent 101 and the rendering devices 40 may utilize multimedia home networking protocols, such as UPnP AV and/or DLNA. For example, the control agent 101 may act as a DLNA-compliant control point and/or a DLNA-compliant media server during interaction with the rendering devices 40 in the local network 32.

As a second example of use of the controls/indications 201, the user 12 may invoke the control/indication 201 represented by the circle symbol adjacent to the internet media content object B. As a result, the web browser may send a communication to the personalization server 103, and the communication may identify the internet media content object B and/or the corresponding enhanced browser function, such as addition of internet media content object B to a list of favorite media content objects maintained for the user 12 by the personalization server 103. As a result, the personalization server 103 may add the internet content object B to the list of favorite media content objects of the user 12. The personalization server 103 may service a plurality of users and may maintain a list of favorite media content objects for each of the plurality of users. For this reason, the personalization server 103 may identify and/or may authenticate the user 12 before adding the internet media content object B to the list of favorite media content objects for the user 12.

For example, if the user 12 and/or the browser terminal 11 is not recognized by the personalization server 103, the personalization server 103 may request that the user 12 provide identification, such as a username, a password and/or other authentication information. As another example, the personalization server 103 may rely on a piece of text that a web server may store on and later retrieve from the hard drive of the browser terminal 11, known as a “cookie,” to identify the user 12.

FIGS. 4 and 5 depict examples of the webpage 200 with the controls/indications 201 embedded therein, and each of the controls/indications 201 may take other forms relative to the forms shown in FIGS. 4 and 5. For example, the controls/indications 201 may be and/or may include buttons, text, graphic icons, pull-down menus, radio buttons and/or the like. Each of the controls/indications 201 may be arranged in proximity to the internet media content object 202 to which the control/indication 201 applies. Alternatively or additionally, the controls/indications 201 may be arranged in a workspace area 210 of the webpage 200 which may be separate from the internet media content objects 202, as generally illustrated in FIG. 6.

As shown in FIG. 6, the controls/indications 201 may be and/or may include controls to select an enhanced browser function. Further, the controls/indications 201 may be and/or may include controls to select one or more of the internet media content objects 202, such as music objects 220 and/or image objects 221. Symbolic representations 212 of the internet media content objects 202 may be used to select one or more of the internet media content objects 202. Still further, the controls/indications 201 may be and/or may include controls to select one or more available rendering devices, such as one or more of the rendering devices 40, and/or one or more local media sources, such as one or more of the local media sources 33. Symbolic representations 213 of the available rendering devices and/or the local media sources may be used to select one or more available rendering devices and/or one or more local media sources.

The user 12 may select and/or may invoke one or more of the controls/indications 201 in the workspace area 210. As a result, the web browser and/or an active element of the webpage 200 may send a message to the control agent 101 and/or the personalization server 103 to invoke the enhanced browser functions associated with the control/indication 201 selected by the user 12.

In some embodiments of the present invention, the controls/indications 201 embedded in the webpage 200 may reflect conditions of the local network 32. For example, as shown in FIG. 5, the carousel of the controls/indications 201 may display a control for each of the rendering devices 40 currently available in the local network 32. The user 12 may invoke a control to select an available rendering device 40 to which the corresponding internet media content object 202 may be redirected. As another example, as shown in FIG. 6, the workspace area 210 may display the controls/indications 201 which are supported by the available rendering devices and/or the local media sources.

Local information may be displayed by the controls/indications 201. In an embodiment, an active element inserted in the webpage 200 may communicate with the control agent 101 in the local network 32 to obtain information about currently available rendering devices 40 and/or local media sources 33. Then, the active element may display the controls/indications 201 which correspond to the available rendering devices 40 and/or local media sources 33. In another embodiment, the control agent 101 may provide information about the available rendering devices 40 and/or local media sources 33 to the registration server 104. Such information may be provided by the registration server 104 to the internet media content website 20 which provides the webpage 200 and/or to the proxy server 102 so that the corresponding controls/indications 201 may be inserted in the webpage 200. The control agent 101 may provide periodic updates to the registration server 104 so that the registration server 104 may maintain a real-time picture of the available devices and/or local media sources in the local network 32.

Embodiments of the present invention may vary in the way the controls/indications 201 are inserted in the webpage 200 by the proxy server 102 and/or the corresponding internet media content website 20. In an embodiment, individual controls/indications 201 may be inserted in the webpage 200 to enable each of the enhanced browser functions. For example, the controls/indications 201 may be distinct links or buttons, each of which enables a specific enhanced browser function for a specific internet media content object 202.

In another embodiment, an active element, such as a script, may be inserted in the webpage 200 with markups and/or indications which inform the active element of the enhanced browser functions enabled for each of the internet media content objects 202 accessible through the webpage 200. The markups and/or the indications may accompany the internet media content object 202, the description of the internet media content object 202, and/or the link to the internet media content object 202 in the source of the webpage 200. The active element may parse the markups and/or the indications to determine the enhanced browser functions which are allowable for each of the internet media content objects 202. The active element may generate and/or may display the controls/indications 201 accordingly to enable the allowable enhanced browser functions in the webpage 200. In some embodiments, the active element may parse the markups and/or the indications by traversing a Document Object Model (DOM) of the webpage 200.

As illustrated in the previous examples, the web browser may display the webpage 200 and the controls/indications 201. The user 12 may select and/or may invoke the controls/indications 201 to implement and/or to control the enhanced browser functions for one or more of the internet media content objects 202 accessible through the webpage 200. As a result, the web browser may communicate with the control agent 101 and/or the personalization server 103. The communication may identify the internet media content object 202, the enhanced browser function, and/or additional information. For example, the additional information may identify a target rendering device 40 and/or a local media source 33, the internet media content website 20, the webpage 200, the user 12, and/or the like. As a result, the control agent 101 and/or the personalization server 103 may perform the selected enhanced browser function for the identified internet media content object 202.

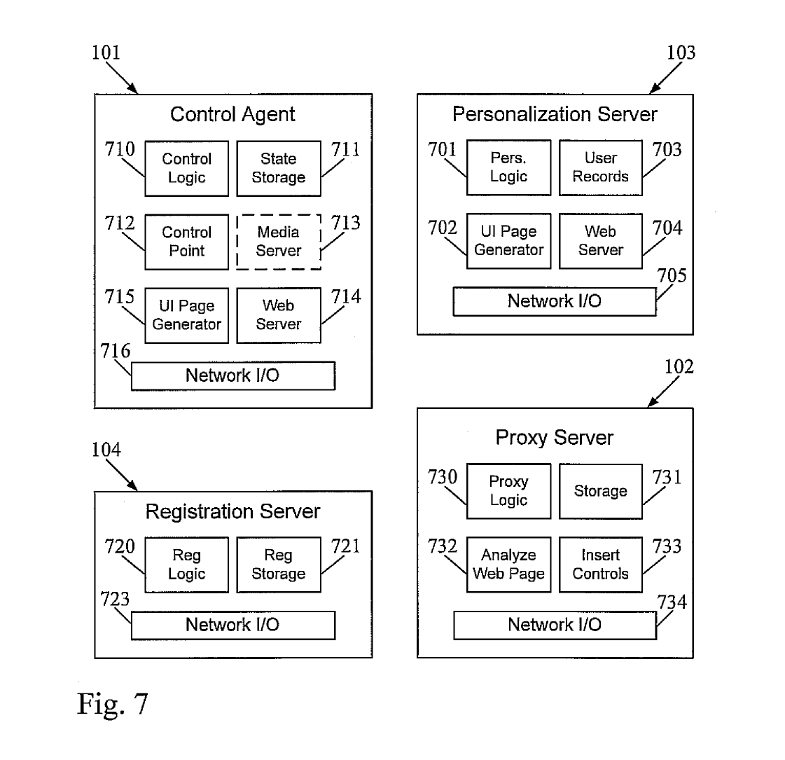

FIG. 7 generally illustrates the functional operation of each of the internet media enhancement components 101,102,103,104 in an embodiment of the present invention. The relationship between the internet media enhancement components 101,102,103,104 is not illustrated in the FIG. 7; an example of the relationship between the internet media enhancement components 101,102,103,104 is generally illustrated in FIG. 3 and will be further elaborated upon hereafter.

The personalization server 103 may have a personalization logic element 701 which may control other components of the personalization server 103. The personalization logic element 701 may provide programming logic for implementing the enhanced browser functions supported by the personalization server 103. The personalization logic element 701 may parse messages sent to the personalization server 103 by the browser terminal in response to the user 12 interacting with the controls/indications 201 embedded in the webpage 200. In parsing the incoming messages, the personalization logic element 701 may identify the internet media content object 202, the enhanced browser function, and/or the related information which may be specified in the messages.

In response, the personalization logic element 701 may take actions to perform the specified enhanced browser function for the internet media content object 202 specified by the message. For example, the personalization logic element 701 may identify and/or authorize the user 12 based on one or more of the personalization records maintained by the personalization logic element 701 and/or stored in a user records element 703. The personalization logic element 701 may alter one or more of the personalization records to add the internet media content object 202 specified by the message to a list of favorite media content objects, a playlist, a history of media content objects accessed and/or used by the user, and/or the like.

The personalization server 103 may have a personalization UI page generator element 702. The personalization logic element 701 may instruct the personalization UI page generator element 702 to create a user interface webpage which may enable the user 12 to organize a list of favorite media content objects associated with the user 12 and/or a history of media content objects accessed and/or used by the user 12; access a list of favorite media content objects associated with the user 12 and/or a history of media content objects accessed and/or used by the user 12; create, manage, and/or use playlists; identify and/or authenticate the user 12; and/or the like.

In response to the instructions from the personalization logic element 701, the personalization UI page generator 702 may create the user interface webpage. Then, the user interface webpage may be sent to the browser terminal 11 to request additional interaction between the user 12 and the personalization server 103. More generally, the personalization logic element 701 may interact with and/or control the other components of the personalization server 103 in accordance with any of the various functions of the personalization server 103 disclosed herein.

The personalization server 103 may have the user records element 703 which may store the personalization records associated with various users. The user records element 703 may store the personalization records which may identify and/or authenticate each of the various users. The personalization records may be and/or may include, for example, a username, a unique user ID, a proper name, a password, an authentication token, a cookie, and/or the like. The personalization server 103 may provide a user interface webpage, such as a “log-in page,” which may enable the user 12 to provide input in an identification field and/or an authorization field. The personalization server 103 may provide a user interface webpage which enables the user 12 to manage account information; create an account; update the identification field, such as the username; update the authentication field, such as the password; and/or the like.

The personalization server 103 may provide the log-in page in response to a message from the browser terminal 11 if the personalization server 103 is not able to identify or authenticate the user 12 based on the message. The user may enter credentials, such as a username and a password, in the log-in page. As a result, the personalization server 103 may identify and/or may authenticate the user 12 based on the credentials entered.

After authentication, the personalization server 103 may update the personalization records to indicate that the user 12 was authenticated. For example, the personalization server 103 may record the time and the date of the authentication. As another example, the personalization server 103 may record IP Address information which may identify the browser terminal 11 and/or the local network 32 in which the browser terminal 11 resides. After the user 12 is authenticated, the personalization server 103 may provide an authentication token, such as a cookie, to the web browser of the browser terminal 11 of the user 12. The authentication token may be used to identify and/or authenticate the user 12 in subsequent requests to the personalization server 103.

The user records element 703 may store the personalization records associated with the various users. The personalization records may define a list of favorite media content objects, a history of media content accessed and/or used by the user, a set of one or more playlists created by the user, a list of favorite internet multimedia content websites of the user, and/or the like. The personalization records may be updated in response to messages sent from the browser terminal 11 to the personalization server 103. The messages may be initiated when the user 12 selects and/or interacts with one of the controls/indications 201 embedded in the webpage 200. The messages may be initiated when the user 12 interacts with a user interface webpage provided by the personalization server 103.

The personalization server 103 may have a personalization network I/O element 705 which may enable the personalization server 103 to send and receive data over a network, such as the local network 32 and/or the internet 15. The data may be and/or may include messages sent from the browser terminal 11 to the personalization server 103, responses sent from the personalization server 103, user interface webpages, and/or the like. The personalization network I/O element 705 may support well known data communication protocols such as IP, TCP, UDP, HTTP, and/or the like.

The personalization UI page generator element 702 may create the user interface webpages for transmission to the browser terminal 11. The user interface webpages may include information from the personalization records of the current user and may include controls for organizing, managing, altering and/or using the personalization information. For example, the personalization server 103 may generate user interface webpages for accessing the list of favorite media content objects of a user, for adding an internet media content object 202 to a playlist of a user, for browsing a history of media content objects accessed and/or used by a user, and/or the like.

The personalization server 103 may have a personalization web server element 704 which may make the user interface webpages available in response to request messages received from the browser terminal 11. The request messages may be HTTP GET requests which may be created when a user interacts with the controls/indications 201 embedded in the webpage 200 and/or when a user interacts with a user interface webpage previously provided by the personalization server 103. The personalization web server element 704 may interact with the personalization logic element 701 and/or the personalization UI page generator element 702 to generate the user interface webpage for a specific request message. Then, the personalization web server element 704 may transmit the user interface webpage to the browser terminal 11. For example, the personalization web server element 704 may transmit the user interface webpage to the browser terminal 11 as an HTTP response message.

As an example, one of the internet media content websites 20 and/or the proxy server 102 may embed the controls/indications 201 in a webpage 200. The controls/indications 201 may include an enhanced browser function which adds an internet media content object 202 to a playlist (hereafter “the add-to-playlist enhanced browser function”). The add-to-playlist enhanced browser function may rely on an personalization server 103 accessible over the internet 15. The webpage 200 may take the form generally illustrated in FIG. 4, and in this particular example, the triangle symbol may be a control/indication 201 for adding the internet media content object A to a playlist. When the user 12 invokes the control/indication 201 corresponding to the triangle symbol, the web browser may send an HTTP GET message to the personalization server 103 as follows:

GET /add-to-
playlist?object=www.contentsite.com/top10/anthem.
mp3&page=www.contentsite.com/top10 HTTP/1.1
Host: www.personalizationserver-0157.com
User-Agent: MyBrowser/v1.2
Accept: text/html

The personalization server 103 which may be located at www.personalizationserver-0157.com may receive the GET message through the personalization network I/O element 705. Then, the personalization server 103 may parse the message using the personalization logic element 701. As a result, the personalization server 103 may identify that the user 12 is attempting to add the internet media content object 202 identified in the message, such as www.contentsite.com/top10/anthem.mp3 in this example, to a playlist using the add-to-playlist enhanced browser function.

The personalization server 103 may not recognize the user 12 because the above example of the HTTP GET message does not have identification information or authentication information for the user 12. The personalization server 103 may utilize the personalization UI page generator element 702 and/or the personalization web server element 704 to return a first user interface webpage. The first user interface webpage may request user input providing the identification information and/or the authentication information, such as a username and/or a password, respectively.

The user 12 may enter the identification information and/or the authentication information in the first user interface webpage. As a result, the personalization server 103 may receive a message which identifies and/or authenticates the user 12. The personalization server 103 may determine if the user records element 702 has personalization records associated with the user 12 and/or may verify that the user 12 is authenticated. The personalization server 103 may provide a cookie to the web browser of the browser terminal 11 of the user 12 so that future messages and/or requests may identify and/or may authenticate the user 12 based on the cookie.

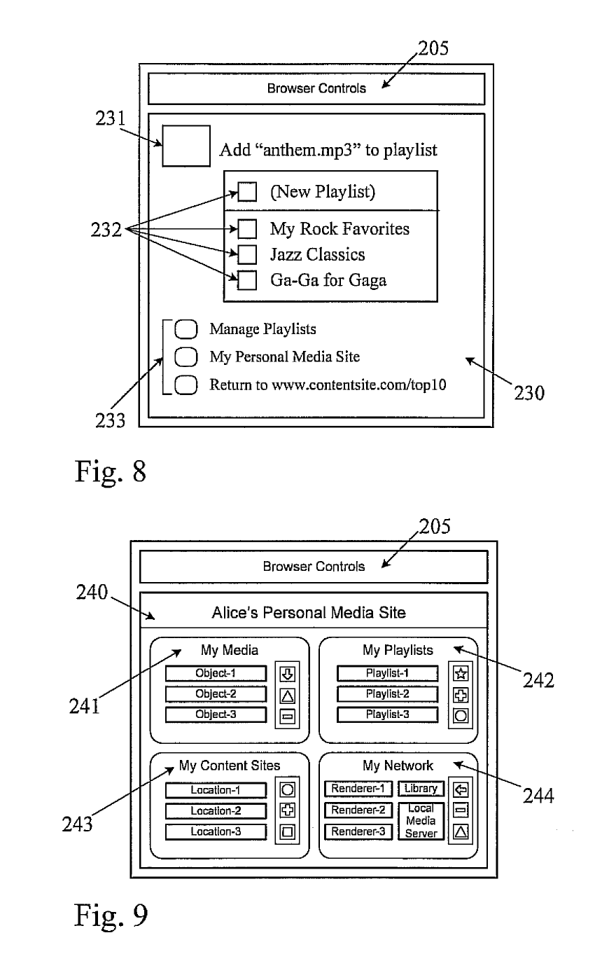

After the user 12 is identified and/or authenticated, the personalization server 103 may respond by providing a second user interface webpage which enables the user 12 to specify additional details relevant to the selected enhanced browser function, such as the add-to-playlist enhanced browser function. The second user interface webpage may include information corresponding to the user 12 from the user records element 703. For example, the second user interface webpage may identify playlists previously created by the user 12 and/or may provide options for the user 12 to add the selected internet media content object 202 to a previously created playlist or to a new playlist. An example of a second user interface webpage 230 is generally illustrated in FIG. 8.

As generally illustrated in FIG. 8, the second user interface webpage 230 may enable the user 12 to add the selected internet media content object 202 to a playlist maintained by the personalization server 103. The second user interface webpage 230 may include a graphic image 231 which may identify the selected internet media content object 202. For example, the graphic image 231 may be an album cover image, an artist image, a thumbnail image, a still frame extracted from a video content object, and/or the like.

The personalization server 103 may contact the internet media content website 20 which provides access to the selected internet media content object 202 to obtain the graphic image 231. For example, the personalization server 103 may retrieve a portion or all of the selected internet media content object 202 to extract the graphic image from the selected internet media content object 202. As another example, the personalization server 103 may extract metadata from the selected internet media content object 202 and/or may use extracted metadata to identify and/or retrieve the graphic image 231 from another source.

The second user interface webpage 230 may have playlist selection controls 232 which may enable the user 12 to select a playlist. The playlist selection controls 232 may identify previously created playlists and/or may enable the user 12 to create a new playlist. The user 12 may select and/or may invoke one of the playlist selection controls 232. As a result, the personalization server 103 may add the selected internet media content object 202 to the playlist.

For example, the personalization server 103 may add the internet media content object identifier, such as “www.contentsite.com/top10/anthem.mp3” in this example, to the personalization record associated with the selected playlist. The user 12 may select and/or may invoke one of the playlist selection controls 232 which creates a new playlist. In response, the personalization server 103 may create a new personalization record for the new playlist and/or may add the internet media content object identifier to the new personalization record.

After adding the selected internet media content object 202 to a new playlist or an existing playlist, the personalization server 103 may present one or more additional user interface webpages (not shown) to enable the user 12 to edit, manage, access and/or use the playlist. Alternatively or additionally, the personalization server 103 may redirect the web browser to return to the original content website, such as “www.contentsite.com/top10” in this example.

The second user interface webpage 230 may include additional navigation controls 233. For example, the additional navigation controls 233 may be and/or may include an option to manage playlists, an option to redirect the web browser to a personal media webpage of the user 12, and/or an option to return to the original content website, such as www.contentsite.com/top10 in this example, without adding the selected internet media content object 202 to a playlist. The user 12 may select and/or may invoke one of the additional navigation controls 233. As a result, the personalization server 103 may present additional user interface webpages and/or may redirect the web browser to return to the original internet media content website.

FIG. 8 generally illustrates an example of the user interface webpage 230 for adding a selected internet media content object 202 to a playlist maintained by the personalization server 103. However, similar user interface webpages may be presented for the other enhanced browser functions supported by the personalization server 103. For example, the user 12 may select and/or may invoke one of the controls/indications 201 which adds a selected internet media content object 202 to a list of favorite media content objects of the user 12. In response, the web browser of the browser terminal 11 of the user 12 may send a message to the personalization server 103. The message may identify the selected internet media content object 202 and/or the enhanced browser function, such as “add_to_favorites.”

As a result, the personalization server 103 may identify and/or may authenticate the user 12; may present a user interface webpage indicating that the selected internet media content object 202 was added to the list of favorite media content objects of the user 12; may enable the user 12 to access, manage and/or use the list of favorite media content objects; may enable the user 12 to access the personal media content website of the user 12; and/or may redirect the web browser on the browser terminal 11 of the user 12 to return to the original internet media content website.

The personalization server 103 may embed the controls/indications 201 in the user interface webpages so that the controls/indications 201 may enable the user 12 to access the enhanced browser functions provided and/or supported by the control agent 101. For example, the personalization server 103 may generate a user interface webpage which provides access to the list of favorite media content objects of the user 12. The personalization server 103 may embed the controls/indications 201 in the user interface webpage to enable the user 12 to redirect internet media content objects 202 in the list of favorite media content objects to one or more of the rendering devices 40 in the local network 32 using the control agent 101.

The user 12 may select and/or may invoke one of the controls/indications 201. As a result, the web browser of the browser terminal 11 of the user 12 may send a message to the control agent 101. The message may identify the internet media content object 202 selected from the list of favorite media content objects. The message may specify the enhanced browser function, such as redirection to a specified rendering device in the local network 32 of the user 12. As a result, the control agent 101 may take actions to use the specified rendering device 40 to begin rendering the internet media content object 202 selected from the list of favorite media content objects as previously set forth. Downloading the internet media content object 202 selected from the list of favorite media content objects to one of the local media sources 33 and/or another local content source using the control agent 101 may be performed in a similar fashion.

FIG. 9 generally illustrates a personal media webpage 240 which may be maintained and/or may be presented by the personalization server 103. For example, the personalization server 103 may send the personal media webpage 240 to the browser terminal 11. The personalization server 103 may use the personalization UI page generator element 702 to create the personal media webpage 240 for the user 12. The personalization server 103 may use the personalization web server element 704 to make personal media webpages, such as the personal media webpage 240, available to the user 12. The personalization server 103 may present links by which the user 12 may access the personal media webpage 240, as previously illustrated in the additional navigation controls presented in FIG. 8.

Referring again to FIG. 9, the personal media webpage 240 may include a personal media area 241, a personal playlist area 242, a personal content websites area 243, a personal network area 244, and/or the like. The personal media area 241 may list internet media content objects 202 which the user has previously accessed, visited and/or added to a list of favorite media content objects. Each of media content objects in the list of favorite media content objects may be selectable by the user 12.

The personal media area 241 may present controls for managing, accessing, and/or using the media content objects in the list of favorite media content objects. For example, one or more of the controls/indications 201 may be presented in the personal media area 241 and may be invoked to utilize the control agent 101 to redirect one or more internet media content objects 202 to one or more of the rendering devices 40 in the local network 32 of the user 12. As another example, one or more of the controls/indications 201 may be presented in the personal media area 241 and may be invoked to utilize the control agent 101 to download one or more internet media content objects 202 to one of the local media sources 33 and/or another local content source. As yet another example, one or more of the controls/indications 201 may be presented in the personal media area 241 and may be invoked to manage, organize and/or edit the list of favorite media content objects using the personalization server 103.

The personal playlist area 242 may list playlists which the user 12 previously created and/or obtained. Each of the playlists may be selectable by the user 12. The playlist area 242 may present the controls/indications 201 for managing, accessing and/or using the listed playlists. For example, one or more of the controls/indications 201 may be presented in the personal playlist area 242 and may be invoked to utilize the control agent 101 to redirect a selected playlist to one or more of the rendering devices in the local network 32 of the user 12. As another example, one or more of the controls/indications 201 may be presented in the personal playlist area 242 and may be invoked to download the selected playlist and/or the internet media content objects 202 referenced therein to the local media sources 33 and/or another local content source.

The user 12 may select and/or may invoke one of the controls/indications 201. As a result, the web browser of the browser terminal 11 of the user 12 may send a message to the control agent 101. The message may identify the selected playlist and/or the media content objects referenced by the selected playlist, and the message may identify the enhanced browser function, such as “redirect to a specific rendering device” or “download to a specific local content source,” for example. As a result, the control agent 101 may take actions to begin rendering the media content objects referenced by the selected playlist on the specified rendering device or to begin downloading the playlist or the media content objects referenced by the playlist to the specified local content source.

One or more of the controls/indications 201 may be presented in the personal playlist area 242 and may be invoked to manage, organize, edit, delete, share and/or create playlists. For example, the user 12 may select a playlist from the personal playlist area 242 and may then invoke one of the controls/indications 201 which edits the selected playlist. As a result, the personalization server 103 may generate and/or may return a user interface webpage which lists the media content objects referenced by the playlist in an editable form. One or more of the controls/indications 201 may be presented in the user interface webpage and may be invoked to add new media content objects to the playlist, delete media content objects from the playlist, reorder media content objects within the playlist, and/or the like.

The personal content websites area 243 may list the internet media content websites 20 which the user 12 previously visited and/or previously added to a list of favorite content websites. For example, the controls/indications 201 embedded in the webpage 200, as previously illustrated in FIGS. 4-6, may enable the user 12 to add the webpage 200 to the list of favorite content websites. As another example, the proxy server 102 may track which internet media content websites 20 the user 12 visits. The proxy server 102 may communicate a history of internet content websites visited by the user 12 to the personalization server 103 for inclusion in the personal content websites area 243 for the user 12.

Each of the internet media content websites 20 listed in the personal content websites area 243 may be selectable by the user 12. Each of the internet media content websites 20 listed in the personal content websites area 243 may be associated with a URL which specifies a webpage for the internet media content website 20. For example, the URL for one of the internet media content websites 20 listed in the personal content websites area 243 may be “www.contentsite.com/aerosmith/videos/”, which may be the web address of a webpage which the user 12 previously visited and/or previously added to the list of favorite content websites of the user 12.

The personal content websites area 243 may present controls by which the user 12 may manage, organize, edit, delete, access and/or use specific internet content websites 20 selected from the list of the internet media content websites 20. For example, one or more of the controls/indications 201 may be presented in the personal content websites area 243 and may be invoked to enable the user 12 to visit a specific internet content website selected from the list of the internet media content websites 20. The user 12 may select the internet content website 20 from the list of the internet media content websites 20 in the personal content websites area 243. Then, the user 12 may select and/or may invoke the control/indication 201 to visit the selected content website 20.

As another example, one or more of the controls/indications 201 may be presented in the personal content websites area 243 and may be invoked to enable the user 12 to redirect internet media content objects 202 from a selected internet media content website 20 to a target rendering device 40 in the local network 32 using the control agent 101. The user 12 may select the internet content website 20 from the list of the internet media content websites 20 in the personal content websites area 243. Then, the user 12 may invoke the control/indication 201 to redirect internet media content objects 202 from the selected internet content website 20 to the target rendering device 40.

As a result, the web browser of the browser terminal 11 of the user 12 may send a message to the control agent 101. The message may identify the URL for the selected internet content website 20 and/or the enhanced browser function, such as “redirect_media_from_content_site.” The message may identify the target rendering device 40 to be used in the redirection. In response, the control agent 101 may contact the internet content website 20, may retrieve the webpage indicated by the URL, and/or may analyze the webpage to detect and/or determine the internet media content objects 202 accessible through the webpage 200. The control agent 101 may take actions to begin rendering the internet media content objects 202 accessible through the webpage 200 on the target rendering device 40. Accordingly, the internet content website 20 and/or a webpage 200 offered by the internet content website 20 may be used as a media container which may be rendered similarly to rendering of a playlist.

The personal network area 244 may list the rendering devices 40 and/or the local media sources 33 available in the local network 32 of the user 12. The personalization server 103 may identify the local network 32 of the user 12 based on the identification of the user 12. Alternatively or additionally, the personalization server 103 may analyze the messages from the web browser of the browser terminal 11 of the user 12 to identify an IP Address associated with the local network 32 of the user 12. The IP Address may be, for example, the globally-routable IP Address of the modem or router which connects the local network 32 to the internet 15. Then, the personalization server 103 may use the IP Address to query the registration server 104 to determine whether a control agent 101 from the local network 32 corresponds to the IP Address. If a control agent 101 which corresponds to the IP Address is identified, the personalization server 103 may then include the information and/or the controls/indications 201 relevant to the rendering devices 40 and/or the local media sources 33.

In an embodiment, the personalization server 103 may include an active element, such as a Javascript active object and/or a Flash active object, in the webpage 200 for the personal media webpage 240. The active element may be capable of contacting the control agent 101 to retrieve and/or display the information and/or the controls/indications 201 relevant to the rendering devices 40 and/or the local media sources 33. In another embodiment, the control agent 101 may send periodic updates of local network information, such as information about the rendering devices 40 and/or the local media sources 33, to the registration server 104. As a result, the personalization server 103 may obtain the local network information, such as the information about the rendering devices 40 and/or the local media sources 33, from the registration server 104. Then, the personalization server 103 may insert the controls/indications 201 in the personal network area 244 accordingly.

One or more of the controls/indications 201 may be presented in the personal network area 244 and may be invoked to redirect internet media content objects 202 to one or more of the rendering devices 40 in the local network 32 of the user 12. One or more of the controls/indications 201 may be presented in the personal network area 244 and may be invoked to download the corresponding internet media content object 202 to the local media sources 33 and/or another local content source.

For example, the user 12 may select “Object-1” from the personal media area 241 and then may select “Renderer-3” in the personal network area 244 which corresponds to one of the rendering devices 40 available in the local network 32 of the user 12. As a result, the web browser of the browser terminal 11 of the user 12 may send a message to the control agent 101 in the local network 32 of the user 12. The message may identify the internet media content object 202 corresponding to “Object-1” and may identify the rendering device 40 corresponding to “Renderer-3.” The control agent 101 may take actions to begin rendering the internet media content object 202 corresponding to “Object-1” on the rendering device 40 corresponding to “Renderer-3.” In a similar manner, the user 12 may select a playlist from the personal playlist area 242 or one of the internet media content websites 20 from the personal content website area 243 to redirect media content objects from the playlist or the internet media content website 20, respectively, to one of the rendering devices 40 identified in and/or selected from the personal network area 244.

The controls/indications 201 presented in the personal media webpage 240 may take various forms, including text links, graphic links, buttons, radio buttons, sliders, menus, carousels and/or the like. In an embodiment, the personalization server 103 may utilize active elements in the webpages which represent the personal media webpage 240 to enhance user interaction. For example, an active element may enable the user 12 to drag one or more symbolic representations displayed in the personal media webpage 240 onto another one of the symbolic representations displayed in the personal media webpage 240, and the other symbolic representation displayed in the personal media webpage 240 may be located in a different area of the personal media webpage 240. Thus, the active element may enable the user 12 to drag “Object-1” and “Object-2” from the personal media area 241 and drop these objects onto “Renderer-2” in the personal network area 244. As a result, the control agent 101 may be used to render the internet media content objects 202 corresponding to “Object-1” and “Object-2” on the rendering device 40 in the local network 32 corresponding to “Renderer-2.”

Similarly, the active element may enable the user 12 to drag “Location-3” from the personal content websites area 243 to “Local Media Server” in the personal network area 244. As a result, all of the internet media content objects 202 accessible from the internet media content website 20 corresponding to “Location-3” may be downloaded to the local media source 33.

The personal media webpage 240 may include other tools to organize, edit, access and/or use the internet media content objects 202, playlists, internet media content websites 20, a history of media content objects accessed and/or used by a user, and/or other data presented by the personal media webpage 240. For example, the personal media webpage 240 may enable the user 12 to edit the list of favorite media content objects. As another example, the personal media webpage 240 may present a search box which enables the user 12 to search for media content objects, playlists, internet content websites, history entries, and/or the like. As yet another example, the personal media webpage 240 may provide a function for performing a search of the internet 15 for internet media content objects 202 and/or internet media content websites 20. The personal media webpage 240 may enable the user 12 to add one or more results from the search to the list of favorite media content objects of the user 12, to a playlist of the user 12, and/or to the list of favorite internet media content websites of the user 12.

The personalization server 103 may provide records which describe the enhanced browser functions performed by the personalization server 103, and such records may be conveyed to the internet media content websites 20 which provide the internet media content objects 202. For example, the personalization server 103 may send a message to an internet media content website 20; the message may indicate that a particular internet media content object 202 was added to a user's list of favorite media content objects, may indicate that a particular internet media content object 202 was added to a playlist by a user, may indicate that a particular webpage was added to a user's list of favorite internet media content websites, and/or the like. The message may identify the enhanced browser function, the relevant internet media content object 202 and/or the relevant webpage. The message may identify the user and/or may provide properties of the user.

In some embodiments, the personalization server 103 may collect records which describe the enhanced browser functions and/or may transmit such records periodically. The records may be transmitted directly to the corresponding internet media content websites 20 or may be transmitted to an intermediary server accessible over the internet 15. The intermediary server may combine records from a plurality of the personalization servers 103 and/or may issue aggregated reports to the corresponding internet media content websites 20 periodically. As a result, the internet media content websites 20 may obtain information about which internet media content objects 202 are being added to lists of favorite media content objects and/or playlists of the users 12, and/or the internet media content websites 20 may obtain information about which webpages are being added to the lists of favorite internet content websites of the users 12.

As shown in FIG. 7, the control agent 101 may have a control agent logic element 710, a control point element 712 and/or a media server element 713. The control agent logic element 710 may control the other components of the control agent 101. The control agent logic element 710 may provide programming logic for implementing the enhanced browser functions supported by the control agent 101. The control agent logic element 710 may parse messages sent to the control agent 101 by the browser terminal 11 in response to the user 12 interacting with the controls/indications 201 embedded in the webpage 200. In parsing the messages from the browser terminal 11, the control agent logic element 710 may identify the internet media content object 202, the enhanced browser function, and/or the related information which may be included in the messages.

In response, the control agent logic element 710 may take actions to perform the enhanced browser function specified in the message for the internet media content object 202 specified in the message. For example, the control agent logic element 710 may instruct the control point element 712 to communicate with a target rendering device 40 in the local network 32. The control agent logic element 710 and/or the control point element 712 may instruct the target rendering device 40 to retrieve and/or begin rendering the internet media content object 202 specified in the message. As another example, the control agent logic element 710 may instruct the media server element 713 to retrieve the internet media content object 202 specified in the message from the corresponding internet content website, transcode the internet media content object 202 for compatibility with one of the rendering devices 40 in the local network 32, and/or make the transcoded version of the internet media content object 202 available to control points and/or the rendering devices 40 in the local network 32. The control agent logic element 710 may interact with and/or control the other components of the control agent 101 in accordance with any of the various functions of the control agent 101 disclosed herein.

The control point element 712 may communicate with the rendering devices 40 in the local network 32, the local media sources 33 in the local network 32, other local content sources in the local network 32, and/or the like to support the enhanced browser functions offered by the control agent 101. To this end, the control point element 712 may discover the rendering devices 40 in the local network 32, the local media sources 33 in the local network 32, other local content sources in the local network 32, and/or the like and may maintain a list of these devices currently available in the local network 32. Discovery of the various devices in the local network 32 may utilize a well-known media home networking protocol, such as UPnP AV or DLNA.

The list of devices available in the local network 32 may be stored using a state storage element 711 of the control agent 101. In some embodiments, the control agent 101 may provide the list of the devices currently available in the local network 32 to the registration server 104. In some embodiments, the control agent 101 may provide periodic updates to the list so that the registration server 104 has a real-time list of the available devices in the local network 32.

The control point element 712 may communicate with a target rendering device of the rendering devices 40 in the local network 32 to initiate rendering of one of the internet media content objects 202 on the target rendering device 40. The control point element 712 may communicate with the target rendering device 40 to obtain a rendering status and/or to control the rendering. Control of the rendering may be directed by the user 12; for example, the control agent 101 may provide a user interface webpage to the web browser of the browser terminal 11 of the user 12, and the user interface webpage may have playback controls for controlling the rendering. The playback controls may include commonly known media playback controls, such as PLAY, PAUSE, STOP, FAST FORWARD, REVERSE, VOLUME UP, VOLUME DOWN, and/or the like.

The user 12 may select, may invoke and/or may interact with the playback controls in the web browser of the browser terminal 11 of the user 12. In response, the web browser of the browser terminal 11 of the user 12 may send messages to the control agent 101. The messages may indicate the playback controls invoked by the user 12. The control agent logic element 710 may parse the messages, may determine the playback controls invoked by the user 12, and/or may instruct the control point element 712 to control the target rendering device accordingly.

As a result, the control point element 712 may send messages to the target rendering device 40 to control the rendering. The control point element 712 may control the rendering using a well-known media control protocol. For example, the control point element 712 may use messages compliant with the UPnP AV standard and/or the DLNA standard. More generally, the control point element 712 may act as a UPnP AV-compliant control point and/or a DLNA-compliant control point.

The control point element 712 may communicate with the local media sources 33 and/or another local content source in the local network 32 to download an internet media content object 202 to the local media sources 33 and/or the other local content source in the local network 32, respectively. The control point element 712 may provide the URL of the internet media content object 202 to the local media sources 33 and/or the other local content source in the local network 32 with instructions to download the internet media content object 202 using the URL. Alternatively or additionally, the control agent 101 may retrieve the internet media content object 202 from an internet media content website 20 and may transfer the internet media content object 202 to the local media sources 33 and/or the other local content source in the local network 32.

The transfer may utilize a well-known transfer protocol, such as, for example, HTTP, FTP, TCP, PTP, DTCP, and/or the like. In an embodiment, the control agent 101 may modify, may reformat and/or may transcode the internet media content object 202 before transferring the internet media content object 202 to the local media sources 33 and/or the other local content source in the local network 32.

The control agent 101 may use the media server element 713 to make the internet media content objects 202 available in the local network 32. The media server element 713 may act as a UPnP media server and/or a DLNA-compliant media server. The media server element 713 may act as a proxy for the internet media content objects 202 so that the rendering devices 40 in the local network 32 may retrieve the internet media content objects 202 from a local area network address. The media server element 713 may support modification, reformatting and/or transcoding of the internet media content objects 202 for compatibility with the rendering devices 40 and/or other devices in the local network 32.

The state storage element 711 may store state records which may indicate the devices currently available in the local network 32. For each available device, the state records may identify a device ID, a device type, a device description, a device model, a device manufacturer, a graphical image depicting the device, a description of the device capabilities, an IP Address associated with the device, a port number, and/or the like. The information stored about each device may be obtained by the control point element 712 as part of the standard device discovery procedure. Some or all of the information stored about each device may be retrieved by the control agent 101 from a remote database which contains additional device information not available through standard device discovery and capability exchange methods.

The state records may indicate a current rendering status of the rendering devices 40 in the local network 32. For example, the state records may indicate that a specific internet media content object 202 is currently being rendered on a specific rendering device 40 available in the local network 32. The state records may include the most recent rendering status provided by the specific rendering device 40. The most recent rendering status may indicate the current playback time, the current volume settings, error conditions, and/or the like. The control agent 101 may use the rendering status to provide feedback to the user 12 through the user interface webpages.

The state records may include the state of one or more rendering queues. A rendering queue may be and/or may include a list of media content objects to be rendered on a specific rendering device 20. The state of the rendering queue may include a list of media content objects; identifiers, such as URLs, for the media content objects in the list; identification of the specific rendering device 40 with which the rendering queue is associated; and/or a record of which media content object is currently being rendered from the rendering queue. The control agent 101 may create, may maintain and/or may manage the rendering queues. The control agent 101 may present queue information from the state records in user interface webpages to enable the user 12 to access, manage, view, edit, rearrange, clear and/or control the rendering queues.

The controls/indications 201 embedded in the webpage 200 may include a control to add a specific internet media content object 202 to a rendering queue associated with a target rendering device 40. In this case, the user 12 may select and/or may invoke the control, and the web browser of the browser terminal 11 of the user 12 may send a message to the control agent 101. The message may specify the internet media content object 202 and may direct the control agent 101 to add the specified internet media content object 202 to the specific rendering queue. In response, the control agent 101 may modify the state records for the rendering queue to add the specified internet media content object 202 to the rendering queue.

The control agent 101 may direct the media content objects listed in a rendering queue to be rendered sequentially using the target rendering device 40 associated with the rendering queue. For example, the control agent logic element 710 may instruct the control point element 712 to monitor the status of rendering of a current media content object to determine when the target rendering device 40 completes rendering of the current media content object. When the control point element 712 determines that the target rendering device completes rendering of the current media content object, the control point element 712 may indicate to the control agent logic element 710 that the target rendering device 40 completed rendering of the current media content object.

When the control point element 712 determines that the target rendering device 40 completes rendering of the current media content object and/or indicates this occurrence to the control agent logic element 710, the control agent logic element 710 may direct the control point element 712 to instruct the target rendering device 40 to begin rendering the next media content object in the rendering queue. Accordingly, the user 12 may add media content objects to a rendering queue, and the control agent 101 may ensure that the media content objects are played from the rendering queue in the sequence that the media content objects are ordered in the rendering queue.

The control agent 101 may have a control agent network I/O element 716 which may enable the control agent 101 to send and receive data over a network, such as the local network 32 and/or the internet 15. The data may include messages sent from the browser terminal 11 to the control agent 101, responses sent from the control agent 101 to the browser terminal 11, user interface webpages, and/or the like. The data may include registration messages sent between the control agent 101 and the registration server 104. The data may include messages sent between the control agent 101 and the rendering devices 40, the local media sources 33, other local content sources, and/or other devices available in the local network 32. The control agent network I/O element 716 may support well known data communication protocols such as IP, TCP, UDP, HTTP, and/or the like.

The control agent 101 may have a control agent UI page generator element 715 which may create user interface webpages for transmission to the browser terminal 11. The user interface webpages may enable the user 12 to specify rendering device preferences; access, manage, view, edit and/or control rendering queues; control rendering of a media content object on a target rendering device 40; organize media content objects on a local content source; and or the like. The user interface webpages may include information from the state records stored by the state storage element 711. For example, the user interface webpages may present the media content objects listed in rendering queues, the playback status of one or more of the rendering devices 40, the devices currently available in the local network 32, and/or the like.

The control agent 101 may have a control agent web server element 714 which may make the user interface webpages available in response to request messages received from the browser terminal 11 of the user 12. The request messages may be HTTP GET requests which may be created when the user 12 interacts with the controls/indications 201 embedded in the webpage 200 and/or when the user 12 interacts with a user interface webpage previously provided by the control agent 101. The control agent web server element 714 may interact with the control agent logic element 710 and/or the control agent UI page generator element 715 to generate the user interface webpage for a specific request message. Then, the control agent web server element 714 may transmit the user interface webpage to the browser terminal 11. For example, the control agent web server element 714 may transmit the user interface webpage to the browser terminal 11 as an HTTP response message.

As an example, one of the internet media content websites 20 and/or the proxy server 102 may embed the controls/indications 201 in the webpage 200 so that the controls/indications 201 include an option to redirect an internet media content object 202 to one of the rendering devices 40 in the local network 32. A control agent 101 accessible over the internet 15 may support and/or may direct performance of this enhanced browser function, namely “redirect_to_renderer.” The webpage 200 may take the form of the example depicted in FIG. 4, and for this example the star symbol may be the control/indication 201 for redirecting an internet media content object 202 to one of the rendering devices 40 using the control agent 101.

In this example, the control/indication 201 represented by the star symbol may be a generic redirection control which is not associated with a specific target rendering device 40. As a result, the controls/indications 201 embedded in the webpage 200 may not be based on the specific rendering devices 40 available in the local network 32. The controls/indications 201 may be configured to enable communication between the browser terminal 11 and the control agent 101 in the local network 32. Configuration of the controls/indications 201 to enable the communication may be based on the control agent 101 periodically registering with the registration server 104 as discussed in detail hereafter.

Continuing the example, the user 12 may be browsing one of the internet media content websites 20 and may desire to redirect a music video object titled “fever.mp4” to one of the rendering devices 40 in the local network 32. When the user 12 invokes the control/indication 201 corresponding to the star symbol adjacent to the representation of the internet media content object 202 in the webpage, the web browser of the browser terminal 11 of the user 12 may send a HTTP GET message to the control agent 101 as follows:

GET
/redirect_to_renderer?objecturl=www.contentsite.com/
jazz/
fever.mp4&siteurl=www.contentsite.com/jazz HTTP/1.1
Host: 10.0.0.99
User-Agent: MyBrowser/v1.2
Accept: text/html

The control agent 101 may receive the message through the control agent network I/O element 716, and the message may be provided to the control agent logic element 710 for parsing. The control agent logic element 710 may analyze the message to determine the internet media content object 202 specified by the message, namely “www.contentsite.com/jazz/fever.mp4,” and/or the enhanced browser function specified by the message, namely “redirect_to_renderer.” The control agent logic element 710 may instruct the control agent UI page generator element 715 to create a first user interface webpage which lists the rendering devices 40 in the local network 32 which are available.

The list of the rendering devices 40 which are available may be based on the rendering devices 40 previously discovered by the control point element 712 and/or recorded in the state storage element 711. The list presented in the first user interface webpage may be filtered based on properties of the internet media content object 202. The filtering may be based on the type of internet media content object, such as audio, video or image. In the current example, the internet media content object 202, namely “fever.mp4,” is an MPEG-4 video file. Therefore, the control agent logic element 710 and/or the control agent UI page generator element 715 may filter the list so that only the rendering devices 40 which are capable of displaying MPEG-4 video files are displayed in the first user interface webpage.

The filtering may account for additional properties of the internet media content object 202, and the additional properties may be compared to capability information of the rendering devices 40. The additional properties of the internet media content object 202 may be and/or may include a media type, a mime type, an encoding method, a bit rate, a sample rate, a video resolution, a file size, and/or other parameters used to encode the internet media content object 202. The capability information may have been previously discovered and/or retrieved by the control agent 101 using the control point element 712 and/or may have been stored using the state storage element 711.

The additional properties of the internet media content object 202 may be included in a message sent to the control agent 101 from the web browser of the browser terminal 11. Alternatively or additionally, the control agent 101 may communicate with the corresponding internet media content website 20 to obtain the additional properties of the internet media content object 202. For example, the control agent 101 may retrieve metadata about the internet media content object 202 from the corresponding internet media content website 20 and/or may retrieve some or all of the internet media content object 202 to extract metadata from the internet media content object 202.

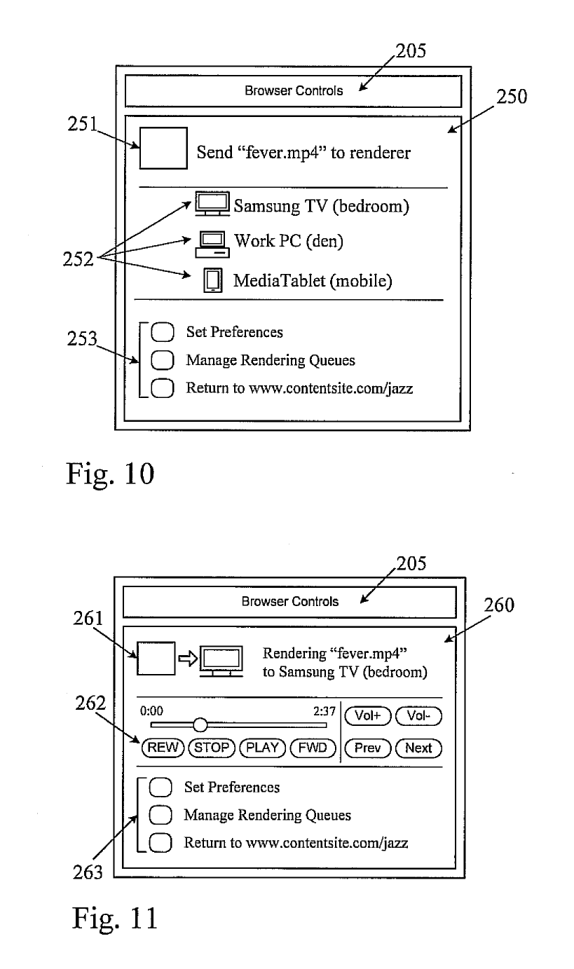

FIG. 10 generally illustrates an embodiment of the first user interface webpage 250 which lists the rendering devices 40 in the local network 32 which are available. The first user interface webpage 250 may have a graphic image 251 representative of the selected internet media content object 202. For example, the graphic image 251 may be an image thumbnail, an album cover, an artist image, a representative video frame, and/or the like.

The first user interface webpage 250 may have renderer selection controls 252 which may list the rendering devices 40 which are available in the local network 32 and/or which have rendering capabilities which correspond to the selected media content object 202. In the example illustrated in FIG. 10, the renderer selection controls 252 in the first user interface webpage 250 may list a Samsung TV located in the bedroom, a Work PC located in the den, and a Media Tablet which is mobile. The renderer selection controls 252 may be textual links, graphic links, buttons, menu items and/or any controls suitable for display in a webpage.

The user 12 may select and/or may invoke one of the renderer selection controls 252 in the first user interface webpage 250. As a result, the web browser of the browser terminal 11 of the user 12 may send a message to the control agent 101 identifying the rendering device 40 corresponding to the selected renderer selection control 252 and/or specifying the selected internet media content object 202 identified by the graphic image 251. In response, the control agent 101 may take actions to begin rendering the selected internet media content object 202 on the rendering device 40 corresponding to the selected renderer selection control 252. For example, the control point element 712 may instruct the rendering device 40 corresponding to the selected renderer selection control 252 to begin rendering the selected internet media content object 202.

The first user interface webpage 250 may have additional navigation controls 253. For example, the additional navigation controls 253 may be and/or may include an option to set preferences, an option to manage rendering queues, and/or an option to return to the original internet media content website 20, namely www.contentsite.com/jazz in this example, without rendering the selected internet media content object 202.

The user 12 may select and/or may invoke one of the additional navigation controls 253. As a result, the control agent 101 may present additional user interface webpages and/or may redirect the web browser of the browser terminal 11 of the user 12 to return to the original internet media content website 20.

In the example illustrated in FIG. 10, the user 12 may select the renderer selection control 252 for the Media Tablet from the first user interface webpage 250. In response, the control agent 101 may take actions to initiate the rendering of “fever.mp4” on the Media Tablet. In addition, the control agent 101 may present a second user interface webpage which may indicate that rendering began and/or may present playback controls as discussed in more detail hereafter.

An example of the second user interface webpage 260 is generally illustrated in FIG. 11. The second user interface webpage 260 may have graphic images 261 which may indicate that a specific rendering device 40 is rendering a specific internet media content object 202. The graphic images 261 may include a graphical depiction of the internet media content object 202 and/or the rendering device 40. Alternatively or additionally, a textual description of the internet media content object 202 and/or the rendering device 40 may be presented.

The second user interface webpage 260 may have playback controls 262. As shown in the example in FIG. 11, the playback controls 262 may include a progress bar which indicates the duration of the internet media content object 202 and/or tracks the rendering progress. The playback controls 262 may include REWIND (“REW”), STOP, PLAY, FAST FORWARD (“FWD”), VOLUME UP (“Vol+”), and VOLUME DOWN (“Vol−”).

The playback controls 262 may include controls for navigating a rendering queue. For example, the playback controls 262 may include an option to skip to the previous item in the queue (“Prev”) and/or an option to skip to the next item in the queue (“Next”). The user 12 may select and/or may invoke one or more of the playback controls 262 displayed in the web browser of the browser terminal 11 of the user 12. As a result, the web browser may send messages to the control agent 101, and the messages may correspond to the one or more playback controls 262 invoked by the user. The control agent 101 may communicate with the target rendering device to control the rendering of the internet media content object 202 in accordance with the one or more playback controls 262 invoked by the user 12.

The second user interface webpage 260 may have additional navigation controls 263. For example, the additional navigation controls 263 may be and/or may include an option to set preferences, an option to manage rendering queues, and/or an option to return to the original internet media content website 20, namely www.contentsite.com/jazz in this example, without rendering the selected internet media content object 202.

The user 12 may select and/or may invoke one of the additional navigation controls 263. As a result, the control agent 101 may present additional user interface webpages and/or may redirect the web browser of the browser terminal 11 of the user 12 to return to the original internet media content website 20.

For the previous example, the controls/indications 201 embedded in the webpage 200 included generic “redirect_to_renderer” controls not associated with a specific target rendering device 40. However, in some embodiments, the controls/indications 201 embedded in the webpage 200 may be and/or may include renderer-specific redirection controls. The renderer-specific redirection controls are generally illustrated in the two examples which follow hereafter.

In a first example, the control agent 101 may register with the registration server 104. The control agent 101 may periodically provide information about each of the available rendering devices 40 in the local network 32 to the registration server 104. The information about each of the available rendering devices 40 in the local network 32 may be and/or may include a device ID, a device type, a description, a model ID, a manufacturer, a graphical image depicting the rendering device 40, a description of the rendering capabilities of the rendering device 40, an IP Address associated with the rendering device 40, a port number of the rendering device 40, and/or the like. In the registration records stored by the registration server 104, information about the available rendering devices 40 in the local network 32 may be grouped together with information about the control agent 101, such as the IP address of the control agent 101 within the local network 32, and/or a globally-routable IP Address associated with the local network 32.

When the internet media content website 20 and/or the proxy server 102 inserts the controls/indications 201 in the webpage 200, the internet media content website 20 and/or the proxy server 102 may query the registration server 104. The internet media content website 20 and/or the proxy server 102 may query the registration server 104 to determine whether a control agent 101 is available in the local network 32, identify the control agent 101, and/or obtain the information about the rendering devices 40 currently available in the local network 32.

Based on the information about the rendering devices currently available in the local network 32, the internet media content website 20 and/or the proxy server 102 may insert renderer-specific redirection controls in the webpage 200 as one or more of the controls/indications 201 embedded in the webpage 200. As a result, the webpage 200 may include multiple redirection controls for an internet media content object 202, and each of the multiple redirection controls may correspond to a different rendering device 40 in the local network 32.

For the example of the webpage 200 generally illustrated in FIG. 4, the controls/indications 201 associated with internet media content object A may correspond to redirection to the Work PC in the den, represented by the “star” symbol; redirection to the Samsung TV in the bedroom, represented by the “triangle” symbol; and redirection to the mobile Media Tablet, represented by the “circle” symbol. In a similar fashion, the controls/indications 201 associated with internet media content object B may correspond to redirection to the Work PC, represented by the “star” symbol, and redirection to the mobile Media Tablet, represented by the “circle” symbol.

The user 12 may select and/or may invoke one of the controls/indications 201 which are renderer-specific redirection controls. As a result, the web browser of the browser terminal 11 of the user 12 may send a message to the control agent 101. The message may identify the internet media content object 202; the enhanced browser function, namely “redirection to renderer”; and/or the specific rendering device 40 selected for the redirection. The message may identify the specific rendering device 40 using the Device ID, the Model ID, and/or the IP Address associated with the rendering device 40. Alternatively or additionally, The message may identify the specific rendering device 40 using another identifier for the rendering device 40. The other identifier may have been provided by the control agent 101 when the control agent 101 registered with the registration server 104. Alternatively or additionally, the other identifier may have been provided by the control agent 101 when the control agent 101 provided a periodic update of local network information to the registration server 104.

In a second example, the internet media content website 20 and/or the proxy server 102 may insert an active element in the webpage 200. The active element may communicate with the control agent 101 in the local network to adapt the controls/indications 201 to the available rendering devices 40 in the local network 32.

For example, the active element may send a message to the control agent 101 which may identify one of the internet media content objects 202 accessible through the webpage 200. The control agent 101 may determine the rendering devices 40 currently available in the local network 32 which are capable of rendering the internet media content object 202 identified in the message. The control agent 101 may respond to the message by sending information about the rendering devices 40 currently available in the local network 32 which are capable of rendering the internet media content object 202. The information may include names of the capable rendering devices 40, unique identifiers for the capable rendering devices 40, graphic images of the capable rendering devices 40, descriptions of the capable rendering devices 40, and/or the like.

The active element use the information to generate and/or present the controls/indications 201 for redirecting the internet media content object 202 to the rendering devices 40 capable of rendering the internet media content object 202. For example, the active element may present the carousel of controls/indications 201 generally illustrated in FIG. 5 so that a graphic image of each of the rendering devices 40 capable of rendering the internet media content object 202 may be displayed as one of the controls/indications 201 in the carousel.

The preceding examples enable the webpage 200 to present the controls/indications 201 which are renderer-specific redirection controls. However, these examples may be extended to enable presentation of controls/indications 201 which are download controls specific to the local media sources 33 and/or other local content sources available in the local network 32. To extend the first example, the control agent 101 may provide information about the local media sources 33 and/or other local content sources available in the local network 32 to the registration server 104. Such information may be retrieved by the internet media content website 20 and/or the proxy server 102 to insert the controls/indications 201 which are storage-specific download controls in the webpage 200.

To extend the second example, an active element inserted in the webpage 200 may communicate with the control agent 101 to obtain the information about the local media sources 33 and/or other local content sources. As a result, the active element may display additional controls in the carousel of control/indications 201, and the additional controls may enable the user 12 to download the internet media content object 202 for storage on one or more of the local media sources 33 and/or other local content sources available in the local network 32.

The control agent 101 may provide records which describe the enhanced browser functions performed by the control agent 101, and such records may be conveyed to the internet media content websites 20 which provide the internet media content objects 202. For example, the control agent 101 may send a message to an internet media content website 20; the message may indicate that a particular internet media content object 202 was redirected to a particular rendering device 40 in the local network 32. The message may identify the internet media content object 202 and/or may describe properties of the rendering device 40, such as the type of rendering device, the manufacturer, the model number, the screen size, the number of audio channels, and/or the like. The message may specify the portion of the internet media content object 202 actually rendered, the time of rendering, and/or the like.

If the control agent 101 performs the enhanced browser function by directly requesting the internet media content object 202 from the internet media content website 20, the message may be combined with the request message which requests the internet media content object 202. Otherwise, the message may be a separate message sent from the control agent 101 to the internet media content website 20.

In some embodiments, the control agent 101 may collect records which describe the enhanced browser functions and/or may transmit such records periodically. The records may be transmitted directly to the corresponding internet media content websites 20 or may be transmitted to an intermediary server accessible over the internet 15. The intermediary server may combine records from a plurality of control agents 101 and/or may issue aggregated reports to the corresponding internet media content websites 20 periodically. As a result, the internet media content websites 20 may obtain information about which internet media content objects 202 are being redirected to external rendering devices 40 and/or what types of external rendering devices to which such content is being redirected. In a similar fashion, the internet media content websites 20 may obtain information about which internet media content objects 202 are being downloaded to local media sources 33 and/or to other storage locations in the local network 32.

FIG. 7 generally illustrates an example of the registration server 104 in an embodiment of the present invention. The registration server 104 may enable the presence of a control agent 101 residing in the local network 32 to be discovered so that selection and/or invocation of the controls/indications 201 embedded in webpages 200 may be communicated to a control agent 101 present in the same local network 32 as the browser terminal 11.

The registration server 104 may be an entity accessible over the internet 15. The registration server 104 may have a known address, such as an IP Address or a URL, so that other entities may access the registration server 104 over the internet 15. A control agent 101 may register its existence with the registration server 104 and/or may register one or more network identifiers which identify the local network 32 in which the control agent 101 resides. The registration server 104 may associate the one or more network identifiers with the control agent 101. Various control agents 101 residing in various local networks 32 may register with the registration server 104 so that the registration server 104 compiles a database of control agents 101 and the corresponding network identifiers.

The control agent 101 may provide additional information about the local network 32 to the registration server 104. For example, the control agent 101 may provide information about the rendering devices 40, the local media sources 33, and/or other local content sources available in the local network 32. If such additional information is provided by the control agent 101, the registration server 104 may associate the additional information with the control agent 101 and/or may record the additional information in the database.

An entity may query the registration server 104 using a network identifier corresponding to a specific local network 32. In response, the registration server 104 may examine the database to determine whether a control agent 101 previously registered using the same network identifier. If a matching control agent 101 is identified, the registration server 104 may return information about the control agent 101 to the entity which queried the registration server 104.

In a first embodiment, the querying entity may be an internet media content website 20 which embeds controls/indications 201 in webpages so that selection and/or invocation of the controls/indications 201 is communicated to the control agent 101 identified by the query. The internet media content website 20 may receive a request from the browser terminal 11 in the local network 32 and then may query the registration server 104 based on a network identifier extracted from the request. The registration server 104 may respond to the query by sending information about a control agent 101 in the local network to the internet media content website 20. Then, the internet media content website 20 may create a webpage 200 with the controls/indications 201 embedded therein so that selection and/or invocation of the controls/indications 201 may be communicated to the control agent 101 in the local network 32.

The query response from the registration server 104 may include information about the control agent 101, and the internet media content website 20 may then incorporate the information in the controls/indications 201. Alternatively or additionally, the query response may include the controls/indications 201 for insertion in the webpage 200 by the internet media content website 20. The internet media content website 20 may embed the controls/indications 201 in the webpage 200 before sending the webpage 200 to the browser terminal 11 in a response message.

In a second embodiment, the querying entity may be a proxy server 102 which may embed the controls/indications 201 in webpages 200 so that selection and/or invocation of the controls/indications 201 may be communicated to the control agent 101 identified by the query. The proxy server 102 may receive a request from the browser terminal 11 in the local network 32. Then, the proxy server 102 may query the registration server 104 based on a network identifier extracted from the request. The registration server 104 may respond to the query by sending information about a control agent 101 in the local network 32 to the proxy server 102.

The proxy server 102 may forward the request to the internet media content website 20 identified in the request. The proxy server 102 may then receive a webpage from the internet media content website 20 in response to the forwarded request. Then, the proxy server 102 may embed the controls/indications 201 in the webpage 200 so that selection and/or invocation of the controls/indications 201 may be communicated to the control agent 101 in the local network 31. The proxy server 102 may send the webpage 200 with the controls/indications 201 embedded therein to the browser terminal 11 in response to the request from the browser terminal 11.

The query response from the registration server 104 may include information about the control agent 101. The proxy server 102 may then incorporate the information in the controls/indications 201. Alternatively or additionally, the query response may include the controls/indications 201 for insertion in the webpage 200 by the proxy server 102. The proxy server 102 may embed the controls/indications 201 in the webpage 200 before sending the webpage 200 to the browser terminal 11 in a response message.

In a third embodiment, the internet media content website 20 and/or the proxy server 102 may embed the controls/indications 201 in the webpage 201, and selection and/or invocation of the controls/indications 201 may query the registration server 104. The web browser of the browser terminal 11 of the user 12 may respond to the selection and/or the invocation of the controls/indications 201 by sending a request message to the registration server 104. The registration server 104 may extract a network identifier from the request message and may examine the database to determine whether a control agent 101 was previously registered using the same network identifier.

If a matching control agent 101 is identified, the registration server 104 may send information about the control agent 101 to the web browser of the browser terminal 11 of the user 12 as a response to the query. As a result, the web browser of the browser terminal 11 of the user 12 may communicate with the control agent 101 to perform enhanced browser functions, such as redirecting internet media content objects 202 to the rendering devices 40 in the local network 32 and/or downloading the internet media content objects 202 to the local media sources 33 and/or other local content sources.

In some embodiments, the control agent 101 and/or the browser terminal 11 may not have direct knowledge of the network identifier which identifies the local network 32 in which the control agent 101 and/or the browser terminal 11 may reside. For example, a control agent 101 present on a device in the local network 32 may be aware only of the local IP Addresses and/or the LAN Addresses of devices in the local network 32. The local IP Addresses and/or the LAN Addresses of devices in the local network 32 may not enable a device outside of the local network 32 to identify the local network 32. The local IP Addresses and/or the LAN Addresses of devices in the local network 32 may not operate as a network identifier in registration messages or queries to the registration server 104. In this case, the control agent 101 may send a message to the registration server 104, and the network identifier may be added to the message by another entity which has knowledge of the network identifier.

For example, the control agent 101 may send a registration message to the registration server 104, and the message may travel through a router and/or a modem device connecting the local network 32 to the internet 15. The router and/or the modem device may insert a globally-routable IP Address in the message before forwarding the message to the registration server 104 over the internet 15. For example, the router and/or the modem device may insert the globally-routable IP Address of the router and/or the modem device, respectively, in the “Source Address” field of the Internet Protocol (IP) layer of the message. The registration server 104 may receive the message, may extract the globally-routable IP Address of the router and/or the modem from the IP layer of the message, and may use the IP Address as the network identifier for identification of the local network 32.

The user 12 may interact with the controls/indications 201 embedded in the webpage 200. As a result, a message may be sent from the browser terminal 11 to the registration server 104. As the message is transmitted to the registration server 104, the message may travel through the router and/or the modem device. The router and/or the modem device may insert the globally-routable IP Address of the router and/or the modem device, respectively, in the message before forwarding the message to the registration server 104 over the internet 15. For example, the router and/or the modem device may insert the globally-routable IP Address in the “Source Address” field of the Internet Protocol (IP) layer of the message. The registration server 104 may receive the message, may extract the globally-routable IP Address of the router and/or the modem device from the IP layer of the message, and may use the globally-routable IP Address as the network identifier for identification of the local network 32.

The network identifier provided by the controls/indications 201 may be matched to the network identifier previously provided by a control agent 101 in a registration message. The network identifiers may match because the browser terminal 11 and the control agent 101 reside in the same local network 32; therefore, the browser terminal 11 and the control agent 101 access the internet 15 through the same router and/or the same modem device.

As illustrated in FIG. 7, the registration server 104 may have a registration logic element 720 which may control the other components of the registration server 104. The registration logic element 720 may provide programming logic to receive and/or parse incoming messages, store and retrieve registration records from a registration storage element 721, create response messages, and/or the like. The registration logic element 720 may parse incoming registration messages from control agents 101 and may direct the registration information received in the registration messages to be stored using the registration storage element 721.

The registration logic element 720 may parse incoming query messages. Then, the registration logic element 720 may search registration records in the registration storage element 721 to determine whether a registered control agent 101 matches the query. The registration logic element 720 may interact with and/or control the other components of the registration server 104 in accordance with any of the various functions of the control agent 101 disclosed herein.

The registration storage element 721 may store registration records which may provide information about control agents 101 which registered with the registration server 104. The registration records may specify a name of a control agent 101, an identifier of a control agent 101, a network identifier for the local network 32 in which the control agent 101 resides, and/or information about devices available in the local network 32 in which the control agent 101 resides. The identifier for a control agent 101 may be an IP Address, a URL, a MAC address, a unique identification number, a unique identification string, and/or another identifier for the control agent 101. The network identifier may be an IP Address, a URL, a MAC address, and/or another identifier for the local network 32 in which the control agent 101 resides. For example, the network identifier may be the globally-routable IP Address of the modem or the router device which connects the local network 32 to the internet 15.

If the control agent 101 provides the information about devices available in the local network 32, the information may include a list of the rendering devices 40, the local media sources 33 and/or other local content sources available in the local network 32. For each of the available devices listed, the information may include a device ID, a device type, a device description, a device model, a device manufacturer, a graphical image depicting the device, a description of the device capabilities, an IP Address associated with the device, a port number, and/or the like.

A registration network I/O element 723 may enable the registration server 104 to send and receive data over a network, such as the local network 32 and/or the internet 15. The data may include incoming registration messages sent from the control agent 101 and/or outgoing registration response messages sent to the control agent 101. The data may include incoming query messages from outside entities, and the incoming query messages may include a network identifier for a local network 32. The data may include outgoing query responses which may identify a control agent 101 in the local network 32 and/or may provide information about the control agent 101 and/or devices present in the local network 32. The information included in the query response may include relevant information stored as registration records in the registration storage element 721 as previously set forth. The registration network I/O element 723 may support well-known data communication protocols, such as IP, TCP, UDP, HTTP and/or the like.

Therefore, a control agent 101 may register with the registration server 104 so that the presence of the control agent 101 in the local network 32 may be discovered. As a result, selection and/or invocation of the controls/indications 201 embedded in the webpage 200 may be communicated to the control agent 101.

In some embodiments, the personalization server 103 may be located in the same local network 32 as the browser terminal 11. In this case, the personalization server 103 may register with the registration server 104 so that selection and/or invocation of the controls/indications 201 embedded in the webpage 200 may be communicated to the personalization server 103.

In other embodiments, the personalization server 103 may be located outside the local network 32 and/or accessible over the internet 15, as depicted in FIG. 3. In this case, the personalization server 103 may have a known internet address and/or a known URL; thus, registration of the personalization server 103 may be unnecessary. Moreover, the personalization server 103 and the personalization records may be accessible without regard to the local network 32 in which the browser terminal 11 may reside.

FIG. 7 generally illustrates an example of the proxy server 102 in an embodiment of the present invention. The proxy server 102 may be a web proxy which may act as an intermediary between the internet media content websites 20 and the web browser of the browser terminal 11 of the user 12. Thus, the proxy server 102 may receive a request for the webpage 200 from the browser terminal 11 and may forward the request to the internet media content website 20 specified in the request.

The proxy server 102 may receive the webpage 200 from the internet media content website 20 and may send the webpage 200 to the browser terminal 11. The web browser and/or the browser terminal 11 may be configured to use the proxy server 102 as a web proxy so that outgoing requests from the web browser and/or the browser terminal 11 may be directed to the proxy server 102. The outgoing requests may be HTTP GET requests, HTTP POST requests, and/or the like.

Before sending the webpage 200 to the browser terminal 11, the proxy server 102 may analyze the webpage 200 to identify the internet media content objects 202 accessible through the webpage 200. The proxy server 102 may embed the controls/indications 201 in the webpage, and the controls/indications 201 may enable enhanced browser functions. Selection and/or invocation of the controls/indications 201 may be communicated to the control agent 101 and/or the personalization Server 103 to provide the enhanced browser functions as previously set forth. The proxy server 102 may send the webpage 200 to the browser terminal 11, and the web browser provided by the browser terminal 11 may present the user 12 with the webpage 200 and the controls/indications 201 embedded therein.

The proxy server 102 may have a proxy logic element 730. The proxy logic element 730 may control the other components of the proxy server 102. The proxy logic element 730 may provide programming logic for parsing incoming request messages from the browser terminal 11, forming outgoing request messages for transmittal to the internet media content websites 20, receiving response messages from the internet media content websites 20, extracting webpages 200 and/or page elements from the response messages, analyzing the webpages 200 and/or page elements, inserting the controls/indications 201, and/or forming outgoing response messages for transmittal to the browser terminal 11. In some embodiments, the proxy logic element 730 may have programming logic for querying the registration server 104 to discover the existence of a control agent 101 and/or a personalization server 103 in the local network 32 as previously set forth.

The proxy server 102 may have a proxy storage element 731 which may provide storage for the webpage 200 and/or page elements as the webpage 200 and/or the page elements are analyzed and/or as the controls/indications 201 are inserted. The proxy storage element 731 may store the controls/indications 201 in a form which may be ready for insertion in the webpage 200.

The proxy storage element 731 may store rules and/or templates for detecting the internet media content objects 202 accessible in the webpage 200 and/or for inserting the controls/indications 201 in the webpage 200. The rules and/or the templates may correspond to popular internet media content websites. For example, the proxy storage element 102 may have one set of rules for detecting the internet media content objects 202 and/or inserting the controls/indications 201 in webpages from www.youtube.com. The proxy storage element 102 may have a different set of rules for detecting the internet media content objects 202 and/or inserting the controls/indications 201 in webpages from www.cnn.com.

The rules and/or the templates may utilize a known structure, format and/or pattern for webpages 200 from a popular internet content website to facilitate detection of the internet media content objects 201 and/or insertion of the controls/indications 201. For an internet media content website 20 for which a specific set of rules and/or templates is not available, the proxy storage element 731 may have a generic set of rules for detecting the internet media content objects 202 and/or inserting the controls/indications 201 in a webpage 200 from the internet media content website 20.

The proxy server 102 may have an analysis element 732 which may have programming logic for analyzing the webpage 300 to detect and/or identify the internet media content objects 202 accessible through the webpage 200. For example, the analysis element 732 may examine HTML page source of the webpage 200 to identify links to the internet media content objects 202 present in the page source. The analysis element 732 may identify the internet media content objects 202 based on syntax elements, such as HTML tags, based on filename suffixes, based on MIME types, and/or the like. The filename suffixes and/or MIME types may identify the internet media content objects 202; for example the suffix “.mp3” may identify an MP3 audio file, and the MIME type “video/mp4” may identify an MP4 video file. The analysis element 732 may identify other structures, such as embedded media players referenced by the page source, to determine that the internet media content object 202 is accessible through the webpage 200.

The analysis element 732 may use previously-acquired information about the internet media content website 20 to identify the internet media content objects 202 accessible through a webpage 200 from the internet media content website 20. For example, a specific internet media content website 20, such as www.contentsite.com, may be known to use a specific URL format to provide access to video media objects as follows:

www.contentsite.com/vobject?id=[IDENTIFIER]

In the above link, “[IDENTIFIER]” may be known to be a unique identification string corresponding to a specific video content object available from the internet media content website 20. Therefore, when analyzing a webpage 200 associated with www.contentsite.com, the analysis element 732 may search for the pattern “vobject?id=” to identify video content objects accessible through the webpage 200.

The analysis element 732 may utilize a database of rules and/or templates corresponding to various known internet media content websites 20. Therefore, for each of the internet media content websites 20, the known page structure, format, URL patterns, expected media types, and/or the like may be utilized to identify the internet media content objects 202 accessible through webpages 200 from the internet media content website 20. The rules and/or the templates may be stored in the proxy storage element 731 as previously set forth. Alternatively or additionally, the analysis element 732 may access the rules and/or the templates from a separate database. The separate database may be accessible to the proxy server 102 over a network, such as the internet 15.

The analysis element 732 may identify the internet media content objects 202 accessible through the webpage 200 using the methods disclosed in paragraphs [140]-[182] and FIGS. 4 and 5 of U.S. Patent App. Pub. No. 2011/0060998 to Schwartz et al., assigned to the assignee of the present application and herein incorporated by reference in its entirety. The present invention is not limited to a specific method for identifying the internet media content objects 202 accessible through the webpage 200, and the analysis element 732 may identify the internet media content objects 202 accessible through the webpage 200 using any method known to one having ordinary skill in the art.

The proxy server 102 may have an insert controls element 733 which may embed the controls/indications 201 in the webpage 200. For example, the insert controls element 733 may embed the controls/indications 201 in the webpage 200 at locations corresponding to the internet media content objects 202 identified by the analysis element 732. As previously set forth, the controls/indications 201 may include links, images, buttons, text, menus and/or other controls which may displayed in a webpage 200. The controls/indications 201 may include scripts and/or active elements. Selection and/or invocation of the controls/indications 201 may be communicated to the control agent 101 and/or the personalization server 103. In some embodiments, selection and/or invocation of the controls/indications 201 may query the registration server 104 to discover and/or identify the control agent 101 and/or the personalization server 103 present in the local network 32.

The insert controls element 733 may utilize a database of rules and/or templates corresponding to various known internet media content websites. The rules and/or templates may specify the enhanced browser functions enabled for the internet media content objects 202 typically offered by the known internet media content website. The rules and/or templates may specify how to embed the controls/indications 201 within the known page structure of an internet content website. The rules and/or templates may specify a size, a style, a color, an arrangement, and/or a spatial placement of the controls/indications 201 for a known internet media content website.

Thus, the rules and/or the templates may enable the insert controls element 733 to insert the controls/indications 201 in the webpages 200 of a known internet media content website in a predetermined way so that the controls/indications 201 may blend with the webpage content. the rules and/or the templates may enable the insert controls element 733 to insert the controls/indications 201 in the webpages 200 of a known internet media content website in a predetermined way so that the controls/indications 201 may be accessible to the user 12.

For an internet media content website 20 for which specific rules and/or templates are not available, the insert controls element 733 may have generic rules and/or templates for placing and/or inserting the controls/indications 201 in a webpage 200 from the internet media content website 20. The insert controls element 733 may access the rules and/or the templates stored in the proxy storage element 731 as previously set forth. Alternatively or additionally, the rules and/or the templates may be accessible to the insert controls element 733 from a separate database. For example, the separate database may be accessible to the proxy server 102 over a network, such as the internet 15.

If the query response indicates that a control agent 101 is not available in the local network 32, then the proxy server may omit the controls/indications 201 which require the control agent 101. The proxy server 102 may insert one of the controls/indications in the webpage 200 so that the inserted control/indication 201 may enable the user 12 to download software for a control agent 101 which the user 12 may then install on a device in the local network 32.

A proxy network I/O element 734 may enable the proxy server 102 to send and receive data over a network, such as the local network 32 and/or the internet 15. The data may include incoming request messages from browser terminals 11, outgoing request messages sent to internet media content websites 20, incoming response messages from internet media content sites 20 which may contain webpages 200 and/or elements of webpages, outgoing response messages sent to browser terminals 11 which may contain webpages 200, elements of webpages 200, and/or the controls/indications inserted in the webpages 200. In some embodiments, the data may include outgoing query messages sent to a registration server 104 and/or incoming query responses from the registration server 104. An incoming query response may identify a control agent 101 in the local network 32 and/or may provide information about the control agent 101 and/or about devices available in the local network 32. The proxy network I/O element 734 may support well-known data communication protocols, such as IP, TCP, UDP, HTTP, and/or the like.

An example generally illustrating the function of the proxy server 102 follows hereafter and references FIG. 3. The user 12 may be using a web browser on the browser terminal 11, and the web browser may be configured to use the proxy server 102 as a web proxy. The proxy server 102 may be capable of inserting the controls/indications 201 so that selection and/or invocation of the controls/invocations 201 may utilize the control agent 101 and/or the personalization server 103. The control agent 101 may be available in the same local network 32 as the browser terminal 11. The control agent 101 may have previously registered with the registration server 104, and the registration server 104 may be known to the proxy server 102.

The user 12 may interact with the web browser to navigate to a specific webpage 200 of an internet media content website 20, such as, for example, www.contentsite.com/cat_videos/featured.htm. As a result, the browser terminal 11 may send an HTTP GET request message to the proxy server 102, and the request message may specify the specific webpage 200 as follows:

GET /cat_videos/featured.htm HTTP/1.1
Host: www.contentsite.com
User-Agent: MyBrowser/v1.2
Accept: text/html

The proxy server 102 may analyze the request message to extract a network identifier corresponding to the local network 32 in which the browser terminal 11 resides. The proxy server 102 may use the network identifier to query the registration server 104 and, as a result, may discover the existence of the control agent 101 in the local network 32. In response to the query, the registration server 104 may provide information about the control agent 101 in the local network 32. For example, the registration server 104 may inform the proxy server 102 that the control agent 101 in the local network 32 is named “Media Control Agent on Acme 2400 Router” and is accessible in the local network 32 at IP Address 10.0.0.99.

The proxy server 102 may forward the request message to a web server at the internet media content website 20 identified by the message, namely www.contentsite.com in this example. The proxy server 102 may modify the request message and/or message headers in the request message as appropriate for a message originating from the proxy server 102. In an embodiment, the proxy server 102 may query the registration server 104 and may forward the request message to the internet media content website substantially simultaneously to minimize the processing delay.

The proxy server 102 may receive a response from the internet media content website 20 which may contain the webpage 200 and/or elements of the webpage 200. For example, the response may contain HTML source for the webpage 200. The proxy server 102 may analyze the webpage 200 and/or the HTML source to identify the internet media content objects 202 accessible through the webpage 200. The analysis may use rules and/or templates which incorporate specific knowledge of the internet media content website 20. For example, www.contentsite.com may be known to organize its video content pages in the following form:

<!DOCTYPE html>
<html>
...
<div id=”video-results”>
<!--FIRST VIDEO OBJECT-->
<div class=”video_thumbnail”>

<a href=”/vobject?id=[IDENTIFIER-01]”>
<img src=”/vthumbnails/[IDENTIFIER-01]/default_image.
jpg”> </a>

</div>
<div class=”video_description”>

<h3> Title of Video Object </h3>
Description of Video Object.

</div>
<!--SECOND VIDEO OBJECT-->
<div class=”video_thumbnail”>

<a href=”/vobject?id=[IDENTIFIER-02]”>
<img src=”/vthumbnails/[IDENTIFIER-02]/default_image.
jpg”> </a>

</div>
<div class=”video_description”>

<h3> Title of Video Object </h3>
Description of Video Object.

</div>
...
<!--Nth VIDEO OBJECT-->
<div class=”video_thumbnail”>

<a href=”/vobject?id=[IDENTIFIER-N]”>
<img src=”/vthumbnails/[IDENTIFIER-
N]/default_image.jpg”>
</a>

</div>
<div class=”video_description”>

<h3> Title of Video Object </h3>
Description of Video Object.

</div>
</div>
</html>

The above form may display a list of videos accessible from a webpage 200, and each video may be represented by a selectable thumbnail image with a corresponding text description. This form may represent a video search result page from www.contentsite.com, for example. The webpage 200 may have a repeating pattern as illustrated in the HTML source above; for example, the video object structure may be repeated for each video content object accessible through the webpage 200. The number of video content objects N may vary per webpage 200. For example, the number of video content objects N per webpage 200 may depend on the number of results returned by a video search.

The proxy server 102 may receive HTML source corresponding to the above form from the internet media content website 20. For example, the proxy server 102 may have rules and/or templates corresponding to www.contentsite.com. The rules and/or the templates may specify that for each video content object accessible in webpages 200 sourced from www.contentsite.com, the proxy server 102 may insert the controls/indications 201 which implement the following enhanced browser functions: redirect the internet media content object 202 to one or more of the rendering devices 40 using the control agent 101 in the local network 32, download the internet media content object 202 to one of the local media sources 33 and/or another local content source using the control agent 101 in the local network 32, and/or add the internet media content object 202 to a list of favorite media content objects using the personalization server 103 accessible over the internet 15.

To this end, the rules and/or the templates corresponding to www.contentsite.com may instruct the proxy server 102 to insert the following controls and indications template within each video object definition, immediately before the div with class “video_description”:

<!-- ==================================================
-->

<div class=“inserted-controls”>

&nbsp &nbsp
<a href=“http://[CONTROL_AGENT_ADDRESS]/redirect-

to-renderer?

objecturl=[OBJECTURL]&siteurl=[SITEURL]” title=“Redirect to
a Local Renderer”> <img src=“http://[ICON_SERVER_ADDRESS]/
redirect_icon.bmp”> </a>

&nbsp
<a href=“http://[CONTROL_AGENT_ADDRESS]/download-to-
local-server?

objecturl=[OBJECTURL]&siteurl=[SITEURL]” title=“Download to
a Local Library”>
<img src=“http://[ICON SERVER ADDRESS]/download icon.bmp”>
</a>

&nbsp
<a href=“http://www.personalization-server.com/add-to-
favorites?

objecturl=[OBJECTURL]&siteurl=[SITEURL]” title=“Add to My
Favorite Media”>
<img src=“
http://[ICON_SERVER_ADDRESS]/favorites_icon.bmp”> </a>
</div>
<!-- ===================================================
-->

In the above controls and indications template, the proxy server 102 may insert specific values as follows:

[CONTROL_AGENT_ADDRESS] may be the address of the control agent 101 in the local network 32, as provided by the registration server 104. For example, the address of the control agent 101 in the local network 32 may be 10.0.0.99.

[OBJECTURL] may be a URL which identifies the internet media content object 202 to which an enhanced browser function may be applied. For example, the object URL may be “www.contentsite.com/vobject?id=[IDENTIFIER-01]” where [IDENTIFIER-01] represents a unique identifier for a video content object available from www.contentsite.com. The URL may identify the internet media content object 202 so that the control agent 101 and/or the personalization server 103 may apply the selected enhanced browser function.

[SITEURL] may be the URL of the webpage 200 in which the controls/indications 201 were inserted. For example, the site URL may be www.contentsite.com/cat_videos/featured.htm. This URL may enable the control agent 101 and/or the personalization server 103 to direct the web browser to return to the original webpage 200 as illustrated in previous examples.

[ICON_SERVER_ADDRESS] may be the IP address and/or domain name of a web server and/or an image server which provides image icons which visually represent the controls/indications 201 inserted in the webpage 200. For example, the icon server may provide the icon “redirect_icon.bmp” to represent the control/indication 201 for redirecting the internet media content object 202 to one of the rendering devices 40 using the control agent 101. The icon server function may be provided by the proxy server 102, another component, and/or a different server. The icon server function may be provided by any web server or image server accessible to the web browser of the browser terminal 11 of the user 12.

As a result, the controls/indications 201 may be inserted in the webpage 200 between a selectable thumbnail image of the internet media content object 202 and a description of the internet media content object 202. For a specific example, the proxy server 102 may insert the controls/indications 201 for the first two video objects in a webpage 200 from www.contentsite.com as follows:

<!DOCTYPE html>
<html>
...
<div id=”video-results”>
<!--FIRST VIDEO OBJECT-->
<div class=”video_thumbnail”>

<a href=”/vobject?id=xqz2081937”>
<img src=”/vthumbnails/xqz2081937/default_image.jpg”>
</a>

</div>
<!-- ===================================================
-->

<div class=″inserted-controls″>

&nbsp &nbsp
<a href=″http://10.0.0.99/redirect-to-
renderer?objecturl=

www.contentsite.com/vobject?id=xqz2081937&siteurl=
www.contentsite.com/cat_videos/featured.htm″
title=″Redirect to a Local Renderer″> <img
src=″http://iconserver.com/redirect_icon.bmp″> </a>

&nbsp
<a href=″http://10.0.0.99/download-to-local-
server?objecturl=

www.contentsite.com/vobject?id=xqz2081937&siteurl=
www.contentsite.com/cat_videos/featured.htm″
title=″Download to a Local Library″> <img
src=″http://iconserver.com/download_icon.bmp″> </a>

&nbsp
<a href=″http://www.personalization-server.com/add-to-
favorites?

objecturl=
www.contentsite.com/vobject?id=xqz2081937&siteurl=
www.contentsite.com/cat_videos/featured.htm″ title=″Add to
My Favorite Media″> <img
src=″http://iconserver.com/favorites_{—}
icon.bmp″> </a>

</div>

<!-- ===================================================
-->
<div class=”video_description”>

<h3> Fattest Orange Kitty </h3>
Watch this cat fall off the sofa.

</div>
<!--SECOND VIDEO OBJECT-->
<div class=”video_thumbnail”>

<a href=”/vobject?id=bby8991020”>
<img src=”/vthumbnails/bby8991020/default_image.jpg”>
</a>

</div>
<!-- ===================================================
-->

<div class=″inserted-controls″>

&nbsp &nbsp
<a href=″http://10.0.0.99/redirect-to-
renderer?objecturl=

www.contentsite.com/vobject?id=bby8991020&siteurl=
www.contentsite.com/cat_videos/featured.htm″
title=″Redirect to a Local Renderer″> <img
src=″http://iconserver.com/redirect_icon.bmp″> </a>

&nbsp
<a href=″http://10.0.0.99/download-to-local-
server?objecturl=

www.contentsite.com/vobject?id=bby8991020&siteurl=
www.contentsite.com/cat_videos/featured.htm″
title=″Download to a Local Library″> <img
src=″http://iconserver.com/download_icon.bmp″> </a>

&nbsp
<a href=″http://www.personalization-server.com/add-to-
favorites?objecturl=

www.contentsite.com/vobject?id=bby8991020&siteurl=
www.contentsite.com/cat_videos/featured.htm″ title=″Add to
My Favorite Media″> <img src=″
http://iconserver.com/favorites_{—}
icon.bmp″> </a>

</div>

<!-- ===================================================
-->
<div class=”video_description”>

<h3> Are you my friend </h3>
My cat Freddie loves to sit on the hamster cage and
look down.

</div>
</div>
</html>

For readability in the current example, some special characters are displayed in URL query strings in their original form, and such characters may in practice require additional encoding, such as hexadecimal escape coding.

The proxy server 102 may send the webpage 200 with the controls/indications 201 inserted therein to the browser terminal 11. The web browser of the browser terminal 11 of the user 12 may display the webpage 200 with the controls/indications 201 inserted therein to the user 12. The user 12 may browse the webpage 200 and may interact with the controls/indications 201 corresponding to the internet media content objects 202 accessible through the webpage 200. For example, the user 12 may click “redirect_icon.bmp” as displayed adjacent to the first video object in the webpage 200. As a result, the web browser may send an HTTP GET message to the control agent 101 in the local network 32 as follows:

GET /redirect-to-renderer?objecturl=
www.contentsite.com/vobject?id=xqz2081937&siteurl=

www.contentsite.com/cat_videos/featured.htm HTTP/1.1

Host: 10.0.0.99
User-Agent: MyBrowser/v1.2
Accept: text/html

As a result, the control agent 101 may take actions to redirect the first video object to one of the rendering devices 40 in the local network 32. For example, the control agent 101 may send a first user interface webpage 250 which displays the rendering devices 40 which are available and enables the user 12 to select one of the rendering devices 40 for the redirection as previously set forth with reference to FIG. 10.

The preceding example may be extended. First, while the preceding example inserted the controls/indications 201 in the webpage without regard to the specific rendering devices 40 and/or the specific local media sources 33 in the local network 32, the control agent 101 may provide information about the specific rendering devices 40 and/or the specific local media sources 33 in the local network 32 to the registration server 104. Then, the registration server 104 may provide the information to the proxy server 102 in response to the query.

The information about the specific rendering devices 40 and/or the specific local media sources 33 in the local network 32 may include descriptive text information for these devices, an appropriate icon image for each device, and/or an identification field suitable for identifying the device to the control agent 101. Then, the descriptive text information and/or the icon image may be incorporated in the controls/indications 201 inserted in the webpage 200 so that the user 12 may select an icon and/or a text link which identifies a specific device in the local network 32. The identification field may be incorporated in the “href” which defines the URL by which the control agent 101 is contacted. For example, the query string of the URL may have an additional field “deviceID=[IDENTIFICATION]” which informs the control agent 101 of the specific device in the local network 32 which is the target of the redirection and/or the download. In this case, [IDENTIFICATION] may be the identification field for the specific device in the local network 32, as previously provided to the registration server 104 by the control agent 101.

Second, the proceeding example inserts HTML source including the controls/indications 201 in the webpage 200; but an active element may be inserted in the webpage 200 which presents the controls/indications 201. The active element may be, for example, Javascript, ECMAscript, Flash Actionscript, and/or the like. The active element may present the controls/indications 201 in an interactive way, as previously illustrated in FIG. 5 by the carousel of controls/indications 201. The active element may detect when the user 12 selects and/or invokes one of the controls/indications 201. In response, the active element may direct transmittal of a corresponding message to the control agent 101 and/or the personalization server 103.

In an embodiment, the active element may examine the webpage 200 to detect the internet media content objects accessible through the webpage 200. The active element may present the controls/indications 201 based on the internet media content objects 202 which are detected. For example, the active element may traverse a DOM representation of the webpage 200 to detect the internet media content objects 202. In such an embodiment, the proxy server 102 may not be required to analyze the webpage 200; analysis of the webpage 200 may be performed by the active element which the proxy server 102 inserts in the webpage 200.

In another embodiment, an internet media content website 20 may mark the webpage source to indicate which enhanced browser functions may be enabled for each of the internet media content objects 202 accessible in the webpage 200. For example, the internet media content website 20 may associate an internet media content object 202 with a div of class=“renderable” to indicate that the internet media content object 202 may be redirected to the rendering devices 40 in the local network 32. Additional div classes may be used to indicate other enhanced browser functions disclosed herein.

Then, the internet media content website 20 and/or the proxy server 102 may insert an active element in the webpage 200 to present the controls/indications 201 which enable the enhanced browser functions. The active element may analyze the webpage to detect the internet media content objects 202 within div structures with class=“renderable” and may use such structures to determine the internet media content objects 202 for which the associated controls/indications 201 may enable redirection to rendering devices 40 in the local network 32. Similarly, the active element may detect the internet media content objects 202 within the alternate div structures to determine the internet media content objects 202 which may have the controls/indications 201 which correspond to other enhanced browser functions.

Referring again to FIG. 7, the division of components for the control agent 101, the proxy server 102, the personalization server 103 and/or the registration server 104 is a conceptual division for illustration, and the actual division of functions may differ by embodiment. For example, the analysis element 732 and the insert controls element 733 of the proxy server 103 may be combined into a single element. As another example, the analysis element 732 and the insert controls element 733 may each have their own storage elements. As yet another example, a service provider may implement any of the control agent 101, the proxy server 102, the personalization server 103 and/or the registration server 104 using multiple physical servers which may employ redirection and/or load balancing to distribute incoming requests among the multiple servers. One skilled in the art will recognize numerous implementation variations which maintain the functions and behaviors described for the control agent 101, the proxy server 102, the personalization server 103 and/or the registration server 104, and such variations are encompassed by the present invention.

Various embodiments of the present invention are disclosed hereafter, and each embodiment is described as arrangements and uses of the various components previously described.

In a first embodiment, a service provider may provide control agents 101 for installation in local networks 32 and may operate a registration server 104 with a known internet address. The service provider may provide a package of controls/indications 201 for insertion in webpages 200 by internet media content websites 20. The service provider may deliver the package of controls/indications 201 to selected internet media content websites 20. alternatively or additionally, the service provider may make the package of controls/indications 201 available on a web server so that internet media content websites 20 may incorporate the controls/indications 201 in their webpages 200 by reference using a URL. The package of controls/indications 201 may be an active element; for example, the package of controls/indications 201 may be Javascript.

The package of controls/indications 201 may be capable of analyzing the webpage 200 to detect the internet media content objects 202 accessible through the webpage 200. The package of controls/indications 201 may be capable of detecting markup in the webpage 200 which indicates the enhanced browser functions which may be enabled for each of the internet media content objects 202 accessible over the webpage 200. The service provider may provide instructions to the internet media content websites 20 for marking up the webpages 200 with the controls/indications 201 such that the package of controls/indications 201 may determine preferences of the internet media content website 20 for enabling or disabling the enhanced browser functions on a per-content object basis.

The package of controls/indications 201 may analyze the webpage 200, may identify the internet media content objects 202 accessible over the webpage 200, and may use the markup to determine the enhanced browser functions which may be enabled for each of the internet media content objects 202 identified by the package of controls/indications 201. The package of controls/indications 201 may query the registration server 104 to discover the presence of a control agent 101 in the local network 32. If a control agent 101 in the local network 32 is identified, the package of controls/indications 201 may present the controls/indications 201 to the user 12 in the web browser accordingly. Thus, the user 12 may utilize a standard web browser to access the enhanced browser functions, such as redirection to one of the rendering devices 40 in the local network 32 and/or downloading to the local media sources 33 and/or another local content source. The internet media content websites 20 may choose whether to enable such enhanced browser functions for each of the internet media content objects 202 accessible through the internet media content website 20.

In a second embodiment, the first embodiment discussed above may be extended so that the service provider operates the personalization server 103. In this case, the package of controls/indications 201 may include the controls/indications 201 which use the enhanced browser functions supported by the personalization server 103. The webpage markup and the markup instructions identified may include means for identifying the enhanced browser functions supported by the personalization server 103. Thus, the internet media content website 20 may insert markup in its webpages 200 to enable or disable enhanced browser functions, such as adding an internet media content object 202 to a list of favorite media content objects, adding a webpage 200 to a list of favorite webpages, adding an internet media content object 202 to a playlist, accessing the personal media webpage 240 of the user 12, and/or the like. The package of controls/indications 201 may interpret the markup and may display the controls/indications 201 which provide access to the enhanced browser functions of the control agent 101 and/or the personalization server 103.

In a third embodiment, a service provider may operate a personalization server 103 accessible over the internet 15. The service provider may provide a proxy server 102 which may be capable of inserting the controls/indications 201 in webpages 200 so that the controls/indications 201 enable the user 12 to access enhanced browser functions provided by the personalization server 103. The proxy server 102 may be accessible over the internet 15 and/or may be present in the local network 32 of the user 12. In the former case, the personalization server 103 may be collocated with and/or combined with the proxy server 102. In the latter case, the proxy server 102 may be built into a home networking device, such as a router or a modem; may be built into a consumer electronics device, such as a networked television; and/or may be installable software executed by a home computing device, such as a personal computer.

The browser terminal 11 of the user 12 may have a web browser which may use the proxy server 102 as a web proxy. The service provider may provide instructions and/or software which may assist the user 12 in configuring the proxy settings in the web browser of the browser terminal 11 of the user 12.

The user 12 may use the web browser to browse internet webpages, such as webpages provided by the internet media content websites and/or webpages provided by other websites. The proxy server 102 may receive requests from the web browser of the browser terminal 11 of the user 12 and may forward the requests to the target internet media content websites 20. In response, the proxy server 102 may receive webpages 200 and/or elements of webpages 200 from the internet media content websites 20.

The proxy server 102 may analyze the webpages 200, may identify the internet media content objects 202 accessible through the webpages 200, and/or may insert the controls/indications 201 which enable enhanced browser functions. The enhanced browser functions may utilize the personalization server 103. For example, the enhanced browser functions may enable the user 12 to add one or more of the internet media content objects 202 to a list of favorite media content objects, add one or more of the internet media content objects 202 to a playlist, add a webpage 200 to a list of favorite webpages, access the personal media webpage 240, and/or the like.

The user 12 may select and/or may invoke one of the controls/indications 201 embedded in the webpage 200, and, as a result, the web browser may send a message to the personalization server 103. In response, the personalization server 103 may take actions related to the selected enhanced browser function as previously set forth.

The proxy server 102 may track a history for each of a plurality of users. The history may include websites visited, internet media content websites 20 visited, internet media content objects 202 accessed, and/or the like. The proxy server 102 may use identification information and/or authentication information, such as a user login or a cookie, to associate web browsing and/or media access events with a specific user.

The proxy server 102 may report web browsing and/or media access events to the personalization server 103, and the personalization server 103 may store the history in association with the specific user in the user records element 703. The proxy server 102 and/or the personalization server 103 may then enable the specific user to access the history from any web browser on any device. For example, the personalization server 103 may present the personal media webpage 240 for the user, and the personal media webpage 240 may present a list of previously visited websites and/or webpages 200 and may present a list of previously accessed internet media content objects 202.

In a fourth embodiment, the third embodiment may be extended so that the service provider supports enhanced browser functions using a control agent 101 located in the local network 32. In this case, the proxy server 102 may insert the controls/indications 201 which provide access to the enhanced browser functions supported by the control agent 101 and/or the personalization server 103.

If the browser terminal 11 of the user 12 is not present in a local network 32 with an available control agent 101, the user 12 may access the controls/indications 201 which are related to the personalization server 103. However, the user 12 may not have access to the controls/indications 201 which are related to the control agent 101. Thus, if the user is web browsing on a mobile device while on a train, and the mobile device is connected to the internet 15 over a mobile carrier network, then the proxy server 102 and the registration server 104 may not be able to match the user to a control agent 101. As a result, the controls/indications 201 may enable only the enhanced browser functions provided by the personalization server 103, such as adding internet multimedia content objects 202 to a list of favorite media content objects, editing and accessing playlists, accessing the personal media webpage 240, and/or the like.

In a fifth embodiment, the proxy server 102 may not operate as a web proxy. The proxy server 102 may operate as a web server which may provide search and navigation tools. The browser terminal 11 may utilize the proxy server 102 even if the web browser is a limited web browser which cannot be configured to use a web proxy. The user 12 may navigate to a webpage 200 provided by the proxy server 102, and the webpage 200 may provide a search box and/or may enable the user 12 to type a URL in the webpage 200. If the user 12 enters a search term, the proxy server 102 may execute a search and/or may provide a list of webpages as the search result.

The user 12 may select a webpage 200 from the list of webpages, and/or the user 12 may enter a URL in the top level proxy server page. Then, the proxy server 102 may respond by retrieving the webpage 200 selected by the user 12 and/or sending the webpage 200 selected by the user 12 to the web browser of the browser terminal 11 of the user 12. Thus, the proxy server 102 may operate as a de facto proxy server while not being a true web proxy.

The proxy server 102 may analyze webpages 200, may insert the controls/indications 201 in the webpages 200, may query the registration server 104 to discover the presence or absence of a control agent 101, and/or the like. Thus, the proxy server 102 may implement the proxy server functionality previously set forth even if limitations of the web browser of the browser terminal 11 of the user 12 do not allow for a true web proxy configuration.

Various changes and modifications to the presently preferred embodiments described herein will be apparent to those skilled in the art. Such changes and modifications may be made without departing from the spirit and scope of the present invention and without diminishing its attendant advantages. Such changes and modifications are covered by the appended claims.

We claim:

1. A method for embedding multimedia controls and indications in a webpage wherein the webpage has controls associated with multimedia content objects that are accessible via the internet, the method comprising the steps of:
associating a first control with a first multimedia content object;
using a first device in a local network to retrieve the webpage and the controls from a web server located outside of the local network;
displaying the webpage and the controls on the first device to a user;
invoking the first control using the first device wherein a user invokes the first control;
sending a message from the first device to a second device in the local network in response to the user invoking the first control;
sending a communication from the second device to a rendering device in the local network in response to the message; and
rendering the first multimedia content object on the rendering device in response to the communication.

2. The method of claim 1 wherein the first control is a link that points to a local address of the second device within the local area network.

3. The method of claim 1 wherein the first control is displayed by an active element of the webpage.

4. The method of claim 1 wherein the web server is operated by a content provider and wherein the content provider inserts the controls into the webpage.

5. The method of claim 1 wherein the web server is a proxy server that retrieves the webpage from a content provider web site, inserts the controls into the webpage, and provides the webpage and the controls to the first device.

6. The method of claim 1 further comprising the step of:
providing a registration server located outside of the local network wherein the second device registers with the registration server and further wherein the registration server associates the registration with a network ID that identifies the local network.

7. The method of claim 1 wherein the first device has a standard web browser that is used to display the webpage to the user.

8. The method of claim 1 wherein the second device controls rendering of the first internet multimedia content object on the rendering device.

9. The method of claim 1 wherein the second device transmits a report that specifies the internet multimedia content objects that the second device caused to be rendered using the rendering device and wherein information from the report is delivered to a content provider that provided the webpage.

10. A system for embedding multimedia controls and indications in a webpage wherein the webpage has controls associated with multimedia content objects that are accessible via the internet, the system comprising:
a first control associated with a first multimedia content object;
a first device in a local network wherein the first device retrieves the webpage and the controls from a web server located outside of the local network and displays the webpage and the controls to a user wherein the user invokes the first control using the first device;
a second device in the local network wherein the first device sends a message to the second device in response to the user invoking the first control; and
a rendering device in the local network wherein the second device communicates with the rendering device in response to the message and the rendering device renders the first multimedia content object in response to the communication.

11. The system of claim 10 wherein the second device transmits a report that specifies the internet multimedia content objects that the second device caused to be rendered using the rendering device and wherein information from the report is delivered to a content provider that provided the webpage.

12. The system of claim 10 wherein the first control is a link that points to a local address of the second device within the local area network.

13. The system of claim 10 wherein the first control is displayed by an active element of the webpage.

14. The system of claim 10 wherein the web server is operated by a content provider and wherein the content provider inserts the controls into the webpage.

15. The system of claim 10 wherein the web server is a proxy server that retrieves the webpage from a content provider web site, inserts the controls into the webpage, and provides the webpage and the controls to the first device.

16. The system of claim 10 further comprising:
a registration server located outside of the local network wherein the second device registers with the registration server and further wherein the registration server associates the registration with a network ID that identifies the local network.

17. The system of claim 10 wherein the first device has a standard web browser that is used to display the webpage to the user.

18. The system of claim 10 wherein the second device controls rendering of the first internet multimedia content object on the rendering device.

19. A method for embedding multimedia controls and indications in a webpage wherein the webpage has controls associated with multimedia content objects that are accessible via the internet, the method comprising the steps of:
providing a first device in a local network connected to the internet;
sending a registration message from the first device to a registration server via the internet;
processing the registration message with the registration server to determine a first network ID that identifies the local network in which the first device resides and a local address of the first device within the local network;
storing the first network ID and the local address of the first device in a registration record associated with the first device on the registration server;
sending a request message from a second device in the local network to a web server via the internet;
processing the request message with the web server to determine a second network ID that identifies the local network in which the second device resides;
querying the registration server with the web server using the second network ID wherein the registration server determines that the second network ID matches the first network ID and the registration server returns the local address of the first device to the web server in response to the query; and
returning a webpage to the second device from the web server in response to the request message wherein the webpage has controls and wherein invocation of the controls by a user of the second device causes the second device to communicate with the first device using the local address of the first device.

20. The method of claim 19 wherein the network ID is added to the registration message by a third device wherein the third device connects the local network to the internet.

21. The method of claim 19 wherein the network ID is added to the request message by a third device wherein the third device connects the local network to the internet.

22. The method of claim 19 wherein the network ID is a globally routable IP address associated with the local network.

23. The method of claim 19 wherein the registration server and the web server are combined into one device.

24. The method of claim 19 wherein the web server is a proxy server through which the second device obtains webpages from the internet.

25. The method of claim 19 wherein the web server generates the controls using the local address of the first device as obtained from the registration server and wherein the web server inserts the controls into the webpage before returning the webpage to the second device.

26. The method of claim 19 wherein the registration message identifies a rendering device in the local network wherein the first device and the rendering device are different devices.

27. A method for embedding multimedia controls and indications in a webpage wherein the webpage has controls associated with multimedia content objects that are accessible via the internet, the method comprising the steps of:
transmitting a request message from a first device to a proxy server wherein the request message requests a webpage;
retrieving the webpage from a remote web server via the internet using the proxy server;
inserting controls into the webpage using the proxy server wherein the controls are associated with internet multimedia content objects accessible using the webpage and wherein a first control is associated with a first internet multimedia content object;
providing the webpage and the controls from the proxy server to the first device in response to the request message;
displaying the webpage and the controls to a user of the first device using a web browser on the first device wherein the user invokes the first control using the web browser on the first device; and
transmitting a message from the web browser to a second device in response to the user invoking the first control wherein the message identifies the first multimedia content object.

28. The method of claim 27 wherein the first device is in a local network and the proxy server is outside the local network and accessible to the first device via the internet.

29. The method of claim 27 wherein the first device and the proxy server are located in the same local network.

30. The method of claim 27 wherein the first device and the second device are two different devices in the same local network.

31. The method of claim 27 wherein the first device and the second device are two different devices in a local network wherein the proxy server queries a registration server to obtain the local address of the second device in the local network and further wherein the proxy server generates the first control using the local address of the second device.

32. The method of claim 27 wherein the second device communicates with a rendering device in response to the message wherein the communication causes the rendering device to retrieve the first internet multimedia content object and wherein the communication causes the rendering device to render the first internet multimedia content object wherein the first device, the second device and the rendering device are different devices.

33. The method of claim 27 wherein the second device causes the first internet multimedia content object to be downloaded and stored in a local network in response to the message wherein the first device and the second device are different devices.

34. The method of claim 27 wherein the second device adds the first internet multimedia content object to a list of favorites associated with a user of the first device in response to the message.

35. The method of claim 27 wherein the first control is part of an active element inserted into the webpage by the proxy server.

36. A system for embedding multimedia controls and indications in a webpage wherein the webpage has controls associated with multimedia content objects that are accessible via the internet, the system comprising:
a webpage that provides access to internet multimedia content objects;
an active element executed by a web browser wherein the active element analyzes the webpage and displays controls in the webpage wherein the controls are associated with the internet multimedia content objects;
a webpage source separate from the active element wherein the webpage source includes links to the internet multimedia content objects; and
markup text in the webpage source wherein the markup text indicates for each of the internet multimedia content objects whether the internet multimedia content object is allowed to be redirected to a rendering device wherein the active element displays a redirection control for a first internet multimedia content object if the markup text indicates that the first internet multimedia content object is allowed to be redirected to a rendering device.

37. The system of claim 36 wherein a content provider provides the webpage and inserts the markup text into the webpage source to indicate media functions that are allowed or disallowed for each internet multimedia content object accessible through the webpage.

38. The system of claim 36 wherein a service provider provides the active element as a package available on a web server and a content provider provides the webpage and wherein the content provider incorporates the active element into the webpage by reference using a URL.

39. The system of claim 36 further comprising:
a proxy server that retrieves the webpage source and the markup text from a web server in response to a request from the web browser and wherein the proxy server inserts the active element into the webpage and transmits the webpage to the web browser in response to the request.

40. The system of claim 36 wherein the active element parses the markup text by traversing a document object model of the webpage.
